(19) United States
(12) Patent Application Publication
(10) Pub. No.: US 2021/0380015 A1
(43) Pub. Date: Dec. 9, 2021

(54) ELECTRIC POWER STORAGE AMOUNT BY TYPE CALCULATING APPARATUS, ELECTRIC POWER STORAGE AMOUNT BY TYPE CALCULATING METHOD, AND NON-TRANSITORY COMPUTER-READABLE RECORDING MEDIUM

(71) Applicant: NEC Corporation, Tokyo (JP)

(72) Inventor: Hiroshi NAKAISHI, Tokyo (JP)

(73) Assignee: NEC Corporation, Tokyo (JP)

(21) Appl. No.: 17/335,396

(22) Filed: Jun. 1, 2021

(30) Foreign Application Priority Data
Jun. 8, 2020 (JP) 2020-099303

(51) Int. Cl. B60L 53/66; B60L 53/64; G06Q 50/06; H02J 7/00; B60L 53/65

(52) U.S. Cl. CPC B60L 53/665; B60L 53/64; B60L 53/65; H02J 7/0047; G06Q 50/06

(57) ABSTRACT

An electric power storage amount by type calculating apparatus includes: an acquisition unit configured to acquire charging/discharging history information in which a charge/discharge electric power amount of a storage battery of a mobile object and a type of electric power are correlated and electric power storage amount information indicating an amount of electric power stored in the storage battery; and a calculation unit configured to calculate the amount of electric power stored in the storage battery by types of electric power on the basis of the charging/discharging history information and the electric power storage amount information.

### CROSS-REFERENCE TO RELATED APPLICATION

This application is based upon and claims the benefit of priority from Japanese Patent Application No. 2020-099303, filed Jun. 8, 2020, the disclosure of which is incorporated herein in its entirety by reference.

### TECHNICAL FIELD

The present invention relates to an electric power storage amount by type calculating apparatus, an electric power storage amount by type calculating method, and a non-transitory computer-readable recording medium.

### BACKGROUND ART

Techniques relating to charging/discharging of a storage battery have been proposed.

For example, an electric power charging/selling apparatus described in Japanese Unexamined Patent Application, First Publication No. 2019-096297 (hereinafter referred to as “Patent Document 1”) acquires electric power trading charge information from a server of one or more power supply companies and performs advertising when an electric vehicle is charged and when electric power charged into an electric vehicle is sold. When a user selects one power supply company, the electric power charging/selling apparatus described in Patent Document 1 performs charging or selling of charged electric power between the selected power supply company and the electric vehicle.

Moreover, a distributed power supply control apparatus described in Japanese Unexamined Patent Application, First Publication No. 2013-143901 (hereinafter referred to as “Patent Document 2”) predicts electric power curves at an off peak and a on peak on the basis of a load dispatching state in a time zone in which power consumption from a power distribution line moves from the on peak to the off peak and a load dispatching state in a time zone in which the power consumption moves from the off peak to the on peak. Then, the distributed power supply control apparatus described in Patent Document 2 controls charging/discharging of a storage battery linked with the power distribution line on the basis of the predicted electric power curves.

### SUMMARY

When a mobile object including a storage battery is used, it is possible to perform selling of electric power at a destination of the mobile object. At this time, if the electric power storage amount can be calculated by types of electric power, for example, if the electric power storage amount of green power can be calculated out of the electric power storage amount in the storage battery of the mobile object, it is possible to sell a specific type of electric power such as selling green power.

An example object of the present invention is to provide an electric power storage amount by type calculating apparatus, an electric power storage amount by type calculating method, and a non-transitory computer-readable recording medium that can solve the aforementioned problem.

A first example aspect of the present invention is an electric power storage amount by type calculating apparatus including: a memory configured to store instructions; and a processor configured to execute the instructions to: acquire charging/discharging history information in which a charge/discharge electric power amount of a storage battery of a mobile object and a type of electric power are correlated and electric power storage amount information indicating an amount of electric power stored in the storage battery; and calculate the amount of electric power stored in the storage battery by types of electric power on the basis of the charging/discharging history information and the electric power storage amount information.

A second example aspect of the present invention is an electric power storage amount by type calculating method including: acquiring charging/discharging history information in which a charge/discharge electric power amount of a storage battery of a mobile object and a type of electric power are correlated and electric power storage amount information indicating an amount of electric power stored in the storage battery; and calculating the amount of electric power stored in the storage battery by types of electric power on the basis of the charging/discharging history information and the electric power storage amount information.

A third example aspect of the present invention is a non-transitory computer-readable recording medium storing a program for causing a computer to perform: acquiring charging/discharging history information in which a charge/discharge electric power amount of a storage battery of a mobile object and a type of electric power are correlated and electric power storage amount information indicating an amount of electric power stored in the storage battery; and calculating the amount of electric power stored in the storage battery by types of electric power on the basis of the charging/discharging history information and the electric power storage amount information.

According to the present invention, it is possible to sell a specific type of electric power out of the electric power which is stored in a storage battery of a mobile object.

### BRIEF DESCRIPTION OF THE DRAWINGS

FIG. 1 is a diagram schematically illustrating an example of the configurations of apparatuses in an electric power system according to an example embodiment;

FIG. 2 is a block diagram schematically illustrating an example of a functional configuration of a network server apparatus according to the example embodiment;

FIG. 3 is a diagram illustrating a first example in which a calculation unit according to the example embodiment calculates the amount of electric power for each type of electric power;

FIG. 4 is a diagram illustrating a second example in which a calculation unit according to the example embodiment calculates the amount of electric power for each type of electric power;

FIG. 5 is a diagram illustrating a third example in which a calculation unit according to the example embodiment calculates the amount of electric power for each type of electric power;

FIG. 6 is a diagram illustrating a fourth example in which a calculation unit according to the example embodiment calculates the amount of electric power for each type of electric power;

FIG. 7 is a diagram schematically illustrating another example of a configuration of a mobile object according to the example embodiment;

FIG. 8 is a first diagram illustrating an example of a process which is performed by the electric power system when an owner-side charger/discharger according to the example embodiment charges a mobile object with green energy;

FIG. 9 is a second diagram illustrating an example of a process which is performed by the electric power system when the owner-side charger/discharger according to the example embodiment charges the mobile object with green energy;

FIG. 10 is a first diagram illustrating an example of a process which is performed by the electric power system when the owner-side charger/discharger according to the example embodiment charges the mobile object with non-green energy;

FIG. 11 is a second diagram illustrating an example of a process which is performed by the electric power system when the owner-side charger/discharger according to the example embodiment charges the mobile object with non-green energy;

FIG. 12 is a first diagram illustrating an example of a process which is performed by the electric power system when a load dispatching office-side charger/discharger according to the example embodiment charges a mobile object with non-green energy;

FIG. 13 is a second diagram illustrating an example of a process which is performed by the electric power system when the load dispatching office-side charger/discharger according to the example embodiment charges the mobile object with non-green energy;

FIG. 14 is a third diagram illustrating an example of a process which is performed by the electric power system when the load dispatching office-side charger/discharger according to the example embodiment charges the mobile object with non-green energy;

FIG. 15 is a first diagram illustrating an example of a process which is performed by the electric power system when a mobile object according to the example embodiment discharges green energy to a provider-side charger/discharger;

FIG. 16 is a second diagram illustrating an example of a process which is performed by the electric power system when the mobile object according to the example embodiment discharges green energy to the provider-side charger/discharger;

FIG. 17 is a third diagram illustrating an example of a process which is performed by the electric power system when the mobile object according to the example embodiment discharges green energy to the provider-side charger/discharger;

FIG. 18 is a fourth diagram illustrating an example of a process which is performed by the electric power system when the mobile object according to the example embodiment discharges green energy to the provider-side charger/discharger;

FIG. 19 is a fifth diagram illustrating an example of a process which is performed by the electric power system when the mobile object according to the example embodiment discharges green energy to the provider-side charger/discharger;

FIG. 20 is a flowchart illustrating an example of a procedure in which a network server apparatus according to the example embodiment determines the amount of green power discharged from a mobile object built-in storage battery to a provider-side storage battery;

FIG. 21 is a diagram illustrating an example of a configuration of an electric power storage amount by type calculating apparatus according to the example embodiment;

FIG. 22 is a flowchart illustrating an example of a procedure in an electric power storage amount by type calculating method according to the example embodiment; and

FIG. 23 is a block diagram schematically illustrating a configuration of a computer according to at least one example embodiment.

### EXAMPLE EMBODIMENT

Hereinafter, example embodiments of the present invention will be described, but the following example embodiments do not limit the invention recited in the claims. Moreover, all combinations of features described in the example embodiments are not always essential to means for solving the problem of the present invention.

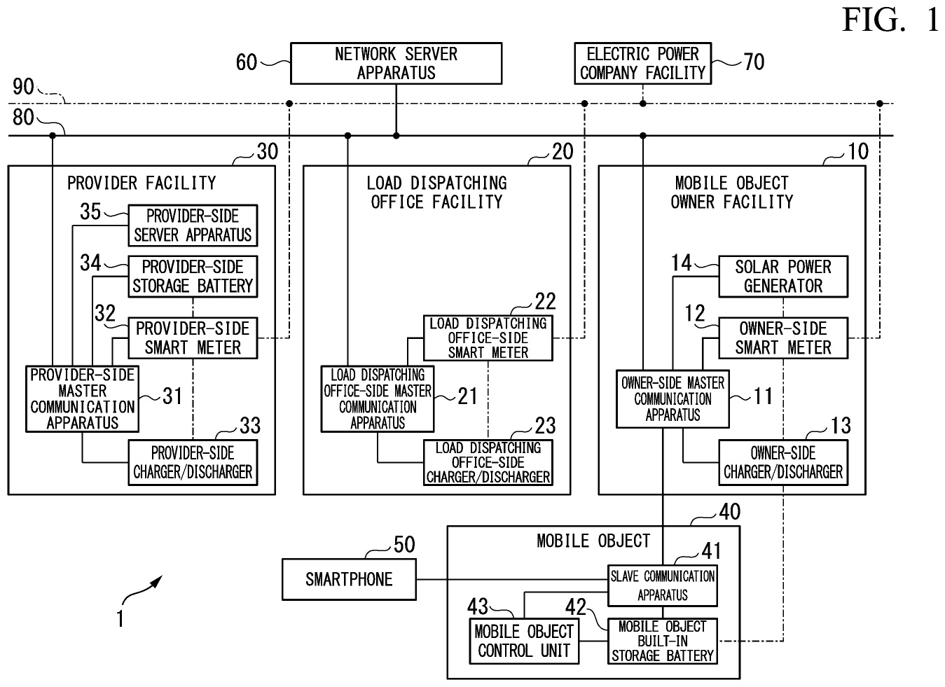

FIG. 1 is a diagram schematically illustrating an example of the configurations of apparatuses in an electric power system according to an example embodiment. In the configuration illustrated in FIG. 1, an electric power system 1 includes a mobile object owner facility 10, a load dispatching office facility 20, a provider facility 30, a mobile object 40, a smartphone 50, a network server apparatus 60, an electric power company facility 70, a communication network 80, and an electric power grid 90. The mobile object owner facility 10 includes an owner-side master communication apparatus 11, an owner-side smart meter 12, an owner-side charger/discharger 13, and a solar power generator 14. The load dispatching office facility 20 includes a load dispatching office-side master communication apparatus 21, a load dispatching office-side smart meter 22, and a load dispatching office-side charger/discharger 23. The provider facility 30 includes a provider-side master communication apparatus 31, a provider-side smart meter 32, a provider-side charger/discharger 33, a provider-side storage battery 34, and a provider-side server apparatus 35. The mobile object 40 includes a slave communication apparatus 41, a mobile object built-in storage battery 42, and a mobile object control unit 43.

The electric power system 1 is a system that sells/buys electric power using the mobile object 40. Here, a mobile object is a movable machine.

Hereinbelow, an example in which the mobile object 40 is an electric vehicle will be described. However, the mobile object 40 is not limited to a specific type of machine and may be a manned machine or an unmanned machine. Various types of machines that are movable and chargeable/dischargeable can be used as the mobile object 40. For example, the mobile object 40 may be an aircraft, a drone, a manned or unmanned ship, or an automatic guided vehicle.

The number of mobile objects 40 which are used for the electric power system 1 has only to be equal to or greater than one. When there is a plurality of mobile objects 40 which are used for the electric power system 1, owners of the plurality of mobile objects 40 may be the same or different from each other. Moreover, the mobile object 40 may be configured as a part of the electric power system 1 or may be a configuration external to the electric power system 1.

The slave communication apparatus 41 communicates with other apparatuses. In particular, when the mobile object 40 is located in the mobile object owner facility 10 and performs charging/discharging of the mobile object built-in storage battery 42, the slave communication apparatus 41 communicates with the owner-side master communication apparatus 11 to exchange information and instructions for charging/discharging such as notification of a charging/discharging electric power amount. When the mobile object 40 is located in the load dispatching office facility 20 and performs charging/discharging of the mobile object built-in storage battery 42, the slave communication apparatus 41 communicates with the load dispatching office-side master communication apparatus 21 to exchange information and instructions for charging/discharging such as notification of a charging/discharging electric power amount. When the mobile object 40 is located in the provider facility 30 and performs charging/discharging of the mobile object built-in storage battery 42, the slave communication apparatus 41 communicates with the provider-side master communication apparatus 31 to exchange information and instructions for charging/discharging such as notification of a charging/discharging electric power amount.

The mobile object built-in storage battery 42 stores electric energy. Electric energy is also referred to as electric power. Accordingly, the term “electric power” is used with both meanings of a meaning of electric energy and a meaning of work which is carried out by a current per unit time.

The electric energy which is stored in the mobile object built-in storage battery 42 is used as energy for allowing the mobile object 40 to move. Moreover, electric energy of an electric power amount that is treated as green power out of the electric energy stored in the mobile object built-in storage battery 42 is to be sold in the provider facility 30.

The mobile object control unit 43 performs various processes such as control of movement of the mobile object 40 and processes for charging/discharging of the mobile object built-in storage battery 42 by controlling the respective units of the mobile object 40. The mobile object control unit 43 may be configured by an on-vehicle computer and the functions of the mobile object control unit 43 may be realized by causing a central processing unit (CPU) of the on-vehicle computer to read a program from a storage unit of the on-vehicle computer and to execute the program.

The mobile object owner facility 10 is a facility that is owned by an owner of the mobile object 40. The mobile object owner facility 10 may be a provider office or a private house. Accordingly, the mobile object 40 may be a vehicle for business use such as a commercial vehicle or a vehicle for personal use (a vehicle for private use).

The owner-side master communication apparatus 11 communicates with other apparatuses. In particular, when the mobile object 40 performs charging/discharging of the mobile object built-in storage battery 42 in the mobile object owner facility 10, the owner-side master communication apparatus 11 communicates with the slave communication apparatus 41 to exchange information and instructions for charging/discharging such as notification of the amount of charge/discharge electric power.

The owner-side smart meter 12 measures the amount of input/output electric power of the respective units of the mobile object owner facility 10. In particular, the owner-side smart meter 12 measures the amount of electric power that is used to charge the mobile object built-in storage battery 42 out of electric power generated by the solar power generator 14. Moreover, the owner-side smart meter 12 measures the amount of electric power that is used to charge the mobile object built-in storage battery 42 out of commercial electric power that is received from the electric power grid 90 by the mobile object owner facility 10.

For example, the owner-side smart meter 12 may include a slave apparatus that measures the amount of electric power generated by the solar power generator 14 and a slave apparatus that measures the amount of charge/discharge electric power between the owner-side charger/discharger 13 and the mobile object built-in storage battery 42. When the amount of electric power generated by the solar power generator 14 is greater than the amount of electric power charged into the mobile object built-in storage battery 42, the whole amount of electric power charged into the mobile object built-in storage battery 42 may be treated as the amount of electric power generated by the solar power generator 14.

The owner-side charger/discharger 13 exchanges electric power with the mobile object built-in storage battery 42 when it is electrically connected to the mobile object built-in storage battery 42. When the mobile object built-in storage battery 42 performs charging, a current flows from the owner-side charger/discharger 13 to the mobile object built-in storage battery 42. When the mobile object built-in storage battery 42 performs discharging, a current flows from the mobile object built-in storage battery 42 to the owner-side charger/discharger 13. The owner-side charger/discharger 13 may be configured as a charging stand.

The solar power generator 14 generates electric power using solar light and outputs the generated electric power. The solar power generator 14 corresponds to an example of a power generation facility that generates green power, and the electric power generated by the solar power generator 14 is treated as green power. However, the facility that generates green power and that is provided in the mobile object owner facility 10 is not limited to a specific type of power generation facility. For example, the mobile object owner facility 10 may include a wind power generator in addition to the solar power generator 14 or instead of the solar power generator 14.

The load dispatching office facility 20 supplies electric power to the mobile object 40. The load dispatching office facility 20 may be configured as a commercial charging station.

The load dispatching office-side master communication apparatus 21 communicates with other apparatuses. In particular, when the mobile object 40 performs charging of the mobile object built-in storage battery 42 in the load dispatching office facility 20, the load dispatching office-side master communication apparatus 21 communicates with the slave communication apparatus 41 to exchange charging information and instructions such as notification of the amount of charging electric power.

The load dispatching office-side smart meter 22 measures the amount of input/output electric power in the load dispatching office facility 20. In particular, the load dispatching office-side smart meter 22 measures the amount of electric power charged into the mobile object built-in storage battery 42 in the load dispatching office facility 20.

The load dispatching office-side charger/discharger 23 exchanges electric power with the mobile object built-in storage battery 42 when it is electrically connected to the mobile object built-in storage battery 42. In particular, a current flows from the load dispatching office-side charger/discharger 23 to the mobile object built-in storage battery 42 to perform charging of the mobile object built-in storage battery 42. The load dispatching office-side charger/discharger 23 may be configured as a charging stand.

Hereinbelow, an example in which all of the charging electric power from the load dispatching office-side charger/discharger 23 to the mobile object built-in storage battery 42 is treated as non-green power will be described. However, when the charging electric power from the load dispatching office-side charger/discharger 23 to the mobile object built-in storage battery 42 can be correlated with power generation sources thereof, some or all of the charging electric power may be treated as green power depending on the power generation sources of the charging electric power.

The provider facility 30 is a facility of a provider that purchases electric power and purchases discharging electric power of the mobile object built-in storage battery 42. Hereinbelow, an example in which the provider facility 30 purchases only green power out of electric power stored in the mobile object built-in storage battery 42 will be described. However, the provider facility 30 may also purchase non-green power. In this case, purchase prices of green power and non-green power may be different.

Moreover, the provider facility 30 may be configured not only to receive electric power discharged from the mobile object built-in storage battery 42 but also to be able to charge the mobile object built-in storage battery 42.

The provider-side master communication apparatus 31 communicates with other apparatuses. In particular, when the mobile object 40 performs charging/discharging of the mobile object built-in storage battery 42 in the provider facility 30, the provider-side master communication apparatus 31 communicates with the slave communication apparatus 41 to exchange information and instructions for charging/discharging such as notification of the amount of charge/discharge electric power.

The provider-side smart meter 32 measures the amount of input/output electric power in the provider facility 30. In particular, the provider-side smart meter 32 measures the amount of electric power discharged from the mobile object built-in storage battery 42 in the provider facility 30.

The provider-side charger/discharger 33 exchanges electric power with the mobile object built-in storage battery 42 when it is electrically connected to the mobile object built-in storage battery 42. In particular, when the mobile object built-in storage battery 42 performs discharging, a current flows from the mobile object built-in storage battery 42 to the provider-side charger/discharger 33. The provider-side charger/discharger 33 may be configured as a charging stand.

The provider-side storage battery 34 stores electric power. In particular, the provider-side storage battery 34 is charged with electric power discharged from the mobile object built-in storage battery 42 (electric power which is bought by the provider) and thus stores the electric power discharged from the mobile object built-in storage battery 42.

The smartphone 50 is a smartphone that is owned by the owner of the mobile object 40. The smartphone 50 serves as a user interface for charging/discharging of the mobile object 40 by communicating with the slave communication apparatus 41. However, the mobile object 40 may include another user interface in addition to the smartphone 50 or instead of the smartphone 50. For example, the mobile object 40 may include a touch panel in a driver's seat as a user interface.

The network server apparatus 60 stores charging/discharging history information in which the amounts of charging/discharging electric power of the mobile object built-in storage battery 42 in the mobile object owner facility 10, the load dispatching office facility 20, and the provider facility 30 are correlated with discrimination between green power and non-green power and charging/discharging date and times.

Moreover, the network server apparatus 60 calculates the amount of green power out of the amount of electric power stored in the mobile object built-in storage battery 42 on the basis of the charging/discharging history information and determines the amount of electric power to be sold from the mobile object built-in storage battery 42 in the provider facility 30.

The network server apparatus 60 corresponds to an example of an electric power storage amount by type calculating apparatus. For example, the network server apparatus 60 is configured by a computer such as a workstation or a person computer (PC).

The electric power company facility 70 is a facility that is provided in an electric power company. The electric power company facility 70 includes a power plant and supplies commercial electric power. Moreover, the electric power company facility 70 includes a server apparatus (not illustrated) and performs a process such as determining the validity of a solar power generator identifier (ID) that is identification information of a solar power generator.

The communication network 80 provides communication paths between the apparatuses. For example, the communication network 80 mediates communication between the owner-side master communication apparatus 11, the load dispatching office-side master communication apparatus 21, the provider-side master communication apparatus 31, the network server apparatus 60, and the smartphone 50.

The electric power grid 90 is a distribution network for commercial electric power. Hereinbelow, an example in which all of the electric power supplied by the electric power grid 90 is treated as non-green power will be described. However, a part of the electric power supplied by the electric power grid 90 may be treated as green power.

Hereinbelow, an example in which the mobile object 40 having departed from the mobile object owner facility 10 arrives at the provider facility 30 and sells green power after the mobile object has been charged in the load dispatching office facility 20 will be described. However, the route of the mobile object 40 is not limited to a specific route. Moreover, places at which the mobile object 40 performs charging/discharging are not limited to specific places.

Furthermore, the number of mobile object owner facilities 10, the number of load dispatching office facilities 20, and the number of provider facilities 30 that are included in the electric power system 1 are not particularly limited to specific numbers as long as the numbers are equal to or greater than one.

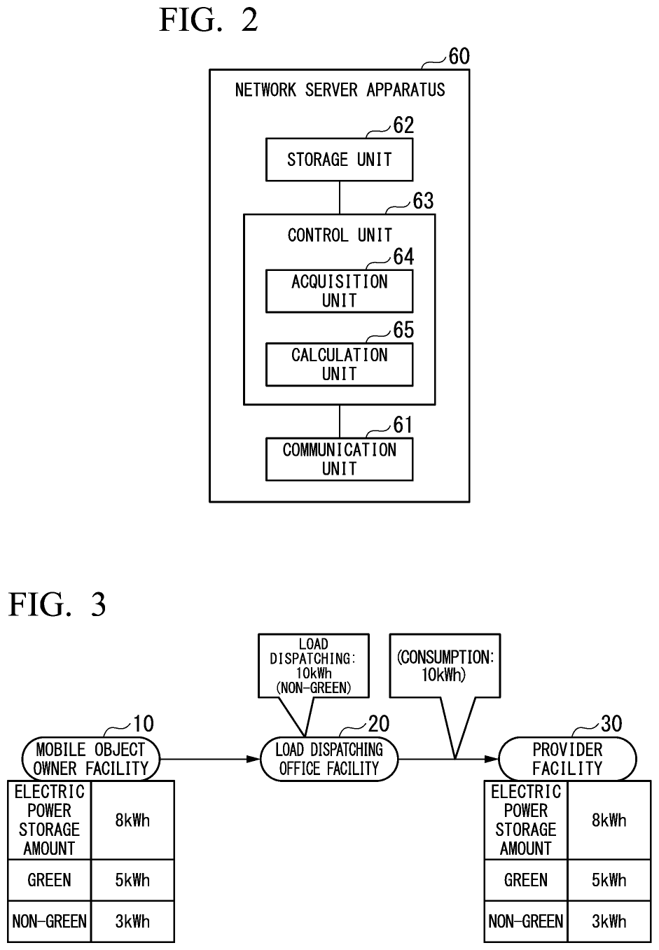

FIG. 2 is a block diagram schematically illustrating an example of a functional configuration of the network server apparatus 60. In the configuration illustrated in FIG. 2, the network server apparatus 60 includes a communication unit 61, a storage unit 62, and a control unit 63. The control unit 63 includes an acquisition unit 64 and a calculation unit 65.

The communication unit 61 communicates with other apparatuses. In particular, the communication unit 61 communicates with the owner-side master communication apparatus 11 to acquire charging/discharging information of the mobile object built-in storage battery 42 in the mobile object owner facility 10. Moreover, the communication unit 61 communicates with the load dispatching office-side master communication apparatus 21 to acquire charging/discharging information of the mobile object built-in storage battery 42 in the load dispatching office facility 20. Furthermore, the communication unit 61 communicates with the provider-side master communication apparatus 31 to acquire charging/discharging information of the mobile object built-in storage battery 42 in the provider facility 30.

The storage unit 62 stores various types of information. For example, the storage unit 62 stores the aforementioned charging/discharging history information. The storage unit 62 is constituted by a storage device that is provided in the network server apparatus 60.

The control unit 63 controls the respective units of the network server apparatus 60 to perform various types of processes. The function of the control unit 63 is realized by causing a CPU provided in the network server apparatus 60 to read a program from the storage unit 62 and to execute the program.

The acquisition unit 64 acquires the charging/discharging history information. For example, the acquisition unit 64 integrates charging/discharging information of the mobile object built-in storage battery 42 which is received by the communication unit 61 from the owner-side master communication apparatus 11, the load dispatching office-side master communication apparatus 21, and the provider-side master communication apparatus 31 into the charging/discharging history information. The acquisition unit 64 stores the acquired charging/discharging history information in the storage unit 62.

The acquisition unit 64 may acquire charging/discharging history information in which the amount of green power charged into the mobile object built-in storage battery 42 is correlated with identification information of a power generation facility having generated the green power. For example, when the mobile object built-in storage battery 42 is charged with electric power generated by the solar power generator 14, the amount of electric power charged into the mobile object built-in storage battery 42 may be correlated with the solar power generator ID of the solar power generator 14 in the charging/discharging history information.

Moreover, the acquisition unit 64 acquires electric power storage amount information indicating the amount of electric power stored in the mobile object built-in storage battery 42. For example, the acquisition unit 64 may acquire information of the electric power storage amount which is calculated by the mobile object built-in storage battery 42 on the basis of a state of charge (SOC) of the mobile object built-in storage battery 42. Alternatively, the acquisition unit 64 may calculate the current amount of electric power stored in the mobile object built-in storage battery 42 on the basis of information of a past amount of electric power stored in mobile object built-in storage battery 42 and charging/discharging information of the mobile object built-in storage battery 42.

When the mobile object 40 includes a power generator or when the mobile object 40 generates electric power by, for example, generating regenerative electric power, the acquisition unit 64 may additionally acquire generated electric power amount information indicating the amount of electric power generated by the mobile object 40.

The acquisition unit 64 may additionally acquire a measured value of the amount of charged/discharged electric power of the mobile object built-in storage battery 42 which is measured at the time of movement of the mobile object 40 by a sensor (not illustrated) provided in the mobile object 40. For example, the sensor may measure the amount of electric power discharged from the mobile object built-in storage battery 42 as driving power of the mobile object 40, and the acquisition unit 64 may acquire the measured value of the amount of electric power. Moreover, when the mobile object built-in storage battery 42 is charged with electric power generated by the mobile object 40, a sensor may measure the amount of electric power charged into the mobile object built-in storage battery 42 and the acquisition unit 64 may acquire the measured value of the amount of electric power.

The sensor that measures the amount of charging electric power and the amount of discharging electric power of the mobile object built-in storage battery 42 may be configured by a single sensor. Alternatively, a sensor that measures the amount of charging electric power and a sensor that measures the amount of discharging electric power may be separately provided.

The sensor that measures the amount of charging electric power and the amount of discharging electric power of the mobile object built-in storage battery 42 may be used not only at the time of movement of the mobile object 40 but also at the time of the mobile object 40 being stopped. For example, the sensor that measures the amount of charging electric power may also measure the amount of charging electric power when the mobile object built-in storage battery 42 is charged in the load dispatching office facility 20.

The calculation unit 65 calculates the amount of electric power stored in the mobile object built-in storage battery 42 by the types of electric power on the basis of the charging/discharging history information and the electric power storage amount information. The types of electric power mentioned herein may be, for example, green power and a non-green power, but are not limited thereto.

Moreover, when the mobile object 40 generates electric power, the calculation unit 65 may calculate the amount of electric power stored in the mobile object built-in storage battery 42 by the types of electric power additionally on the basis of generated electric power information. In this case, the electric power generated by the mobile object 40 may be treated as green power or may be treated as non-green power.

The calculation unit 64 may calculate the amount of electric power stored in the mobile object built-in storage battery 42 by the types of electric power additionally on the basis of the amount of charging electric power and the amount of discharging electric power of the mobile object built-in storage battery 42 at the time of movement of the mobile object 40.

Accordingly, it is possible to more accurately calculate the electric power storage amount (the residual electric power storage amount) of the mobile object 40 by the types of electric power.

When charging of the mobile object built-in storage battery 42 is performed in the load dispatching office facility 20 on a movement route of the mobile object 40, the calculation unit 65 may calculate the amount of electric power stored in the mobile object built-in storage battery 42 at the end of charging in the load dispatching office facility 20 by the types of electric power on the basis of the electric power storage amount for each type of electric power before start of movement of the mobile object 40 and the electric power storage amount in the load dispatching office facility 20.

For example, the calculation unit 65 may acquire information on the amount of electric power stored in the mobile object built-in storage battery 42 by the types of electric power when the mobile object 40 departs from the mobile object owner facility 10. Then, the calculation unit 65 may calculate information on the amount of electric power stored in the mobile object built-in storage battery 42 at the time of completion of charging of the mobile object built-in storage battery 42 in the load dispatching office facility 20 by the types of electric power. Moreover, the calculation unit 65 may calculate information on the amount of electric power stored in the mobile object built-in storage battery 42 at the time of arrival of the mobile object 40 at the provider facility 30 by the types of electric power.

In this way, since the calculation unit 65 acquires the information of the state of charge of the mobile object built-in storage battery 42 when the mobile object 40 is moving and calculates the state of charge of the mobile object built-in storage battery 42 when the mobile object 40 arrives at the provider facility 30, it is possible to acquire information indicating a state of charge that more conforms to the actual condition in comparison with a case in which the state of charge of the mobile object built-in storage battery 42 when the mobile object 40 arrives at the provider facility 30 is calculated on the basis of only the information for when the mobile object 40 departs.

An example in which the calculation unit 65 calculates the electric power storage amount will be described below with reference to FIGS. 3 to 6.

FIG. 3 is a diagram illustrating a first example in which the calculation unit 65 calculates the amount of electric power for each type of electric power.

In the example illustrated in FIG. 3, when the mobile object 40 departs from the mobile object owner facility 10, the mobile object built-in storage battery 42 is storing 5 kilowatt-hours (kWh) of green power and storing 3 kWh of non-green power, that is, storing a total of 8 kWh of electric power. Moreover, the mobile object built-in storage battery 42 is charged with 10 kWh of non-green power in the load dispatching office facility 20. Furthermore, the amount of consumed electric power of the mobile object 40 on a movement route from the mobile object owner facility 10 to the provider facility 30 is 10 kWh.

In the example illustrated in FIG. 3, the amount of electric power consumed in the movement route of the mobile object 40 is acquired, but individual amounts of consumed electric power including the amount of consumed electric power before the mobile object 40 arrives at the load dispatching office facility 20 and the amount of consumed electric power after the mobile object 40 departs from the load dispatching office facility 20 are not apparent.

In this case, the state of charge of the mobile object built-in storage battery 42 when the mobile object 40 arrives at the load dispatching office facility 20 or when the mobile object 40 departs from the load dispatching office facility 20 is not able to be known accurately. Therefore, the calculation unit 65 may calculate the amount of electric power stored in the mobile object built-in storage battery 42 at the time of arrival of the mobile object 40 at the provider facility 30 by the types of electric power on the basis of a total value of the electric power storage amount for each type of electric power of the mobile object built-in storage battery 42 when the mobile object 40 departs from the mobile object owner facility 10 and the amount of supplied electric power in the load dispatching office facility 20.

In the example illustrated in FIG. 3, the calculation unit 65 calculates 13 kWh as the total value of 3 kWh of non-green power amount when the mobile object 40 departs from the mobile object owner facility 10 and 10 kWh of non-green power amount supplied from the load dispatching office facility 20. As for 10 kWh of consumed electric power amount of the mobile object 40, non-green power is assumed to be preferentially consumed and 10 kWh of electric power amount consumed by the mobile object 40 is subtracted from 13 kWh of non-green power amount.

Accordingly, the calculation unit 65 calculates 5 kWh as the amount of green power of the mobile object built-in storage battery 42 when the mobile object 40 arrives at the provider facility 30 and calculates 3 kWh as the amount of non-green power.

In this way, the calculation unit 65 can calculate the amount of electric power stored in the mobile object built-in storage battery 42 at the time of arrival at the provider facility 30 by the types of electric power even when amounts of consumed electric power before and after electric power is supplied in the middle of the route are not apparent out of the amount of consumed electric power of the mobile object 40.

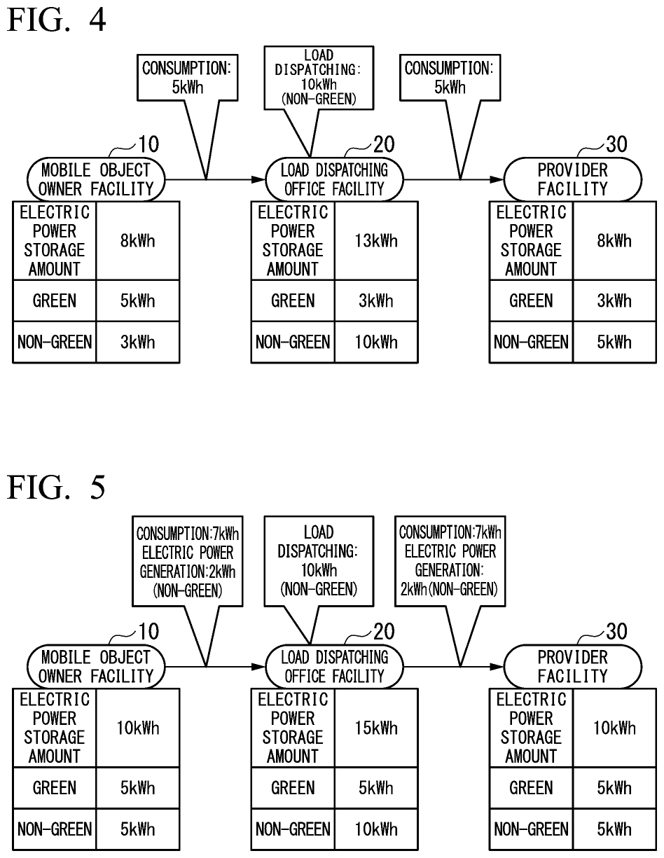

FIG. 4 is a diagram illustrating a second example in which the calculation unit 65 calculates the amount of electric power for each type of electric power.

In the example illustrated in FIG. 4, when the mobile object 40 departs from the mobile object owner facility 10, the mobile object built-in storage battery 42 is storing 5 kWh of green power and storing 3 kWh of non-green power, and thus it is storing a total of 8 kWh of electric power. Moreover, the mobile object built-in storage battery 42 is charged with 10 kWh of non-green power in the load dispatching office facility 20.

Furthermore, unlike the example illustrated in FIG. 3, in the example illustrated in FIG. 4, the amount of consumed electric power of the mobile object 40 is acquired before the mobile object 40 arrives at the load dispatching office facility 20 and after the mobile object 40 departs from the load dispatching office facility 20. The amount of consumed electric power of the mobile object 40 before it arrives at the load dispatching office facility 20 is 5 kWh. The amount of consumed electric power of the mobile object 40 after it departs from the load dispatching office facility 20 is 5 kWh.

In the example illustrated in FIG. 4, the calculation unit 65 assumes that 3 kWh of non-green power is preferentially consumed for 5 kWh which is the amount of consumed electric power of the mobile object 40 before it arrives at the load dispatching office facility 20 and 2 kWh which is the shortfall therein is consumed from 5 kWh of green power. Accordingly, the calculation unit 65 calculates 3 kWh of green power and 0 kWh of non-green power as the electric power storage amount of the mobile object built-in storage battery 42 when the mobile object 40 arrives at the load dispatching office facility 20.

The calculation unit 65 adds 10 kWh of non-green power amount supplied in the load dispatching office facility 20 to 0 kWh of non-green power amount and calculates 3 kWh of green power amount and 10 kWh of non-green power amount, that is, a total of 13 kWh of electric power, as the electric power storage amount of the mobile object built-in storage battery 42 when the mobile object 40 departs from the load dispatching office facility 20.

Moreover, the calculation unit 65 assumes that non-green power is preferentially consumed for 5 kWh which is the amount of consumed electric power of the mobile object 40 after it departs from the load dispatching office facility 20. Accordingly, the calculation unit 65 calculates 3 kWh of green power amount and 5 kWh of non-green power amount, that is, a total of 8 kWh of electric power, as the electric power storage amount of the mobile object built-in storage battery 42 when the mobile object 40 arrives at the provider facility 30.

For a result of comparison between the example illustrated in FIG. 3 and the example illustrated in FIG. 4, the example illustrated in FIG. 4 exhibits a result of calculation that reflects a situation in which the amount of stored non-green power has been used up and the amount of green power has also been consumed before the mobile object 40 arrives at the load dispatching office facility 20. As a result, the example illustrated in FIG. 4 exhibits the result of calculation that more conforms to the actual situation.

FIG. 5 is a diagram illustrating a third example in which the network server apparatus 60 calculates the amount of electric power for each type of electric power. In the example illustrated in FIG. 5, the amount of generated electric power is also acquired in addition to the amount of electric power consumed in the mobile object 40. In this case, electric power generated by the mobile object 40 may be treated as green power or may be treated as non-green power. For example, the calculation unit 65 may treat regenerative electric power as green power and may treat electric power generated using fossils fuel as non-green power.

In the example illustrated in FIG. 5, when the mobile object 40 departs from the mobile object owner facility 10, the mobile object built-in storage battery 42 is storing 5 kWh of green power and storing 5 kWh of non-green power, that is, it is storing a total of 10 kWh of electric power. Moreover, the mobile object built-in storage battery 42 is charged with 10 kWh of non-green power in the load dispatching office facility 20.

Furthermore, in the example illustrated in FIG. 5, the amount of electric power consumed in the mobile object 40 before it arrives at the load dispatching office facility 20 is 7 kWh and the amount of generated electric power is 2 kWh. The amount of electric power consumed in the mobile object 40 after it departs from the load dispatching office facility 20 is 7 kWh and the amount of generated electric power is 2 kWh. FIG. 5 illustrates an example in which the calculation unit 65 treats the electric power generated by the mobile object 40 as non-green power.

In the example illustrated in FIG. 5, the calculation unit 65 assumes that 5 kWh of non-green power and 2 kWh of generated non-green power are preferentially consumed for 7 kWh which is the amount of electric power consumed in the mobile object 40 before it arrives at the load dispatching office facility 20. Accordingly, the calculation unit 65 calculates 5 kWh of green power amount and 0 kWh of non-green power amount as the electric power storage amount of the mobile object built-in storage battery 42 when the mobile object 40 arrives at the load dispatching office facility 20.

The calculation unit 65 adds 10 kWh of non-green power amount supplied in the load dispatching office facility 20 to 0 kWh of non-green power amount. The calculation unit 65 calculates 5 kWh of green power amount and 10 kWh of non-green power amount, that is, a total of 15 kWh of electric power, as the electric power storage amount of the mobile object built-in storage battery 42 when the mobile object 40 departs from the load dispatching office facility 20.

The calculation unit 65 assumes that non-green power is preferentially consumed for 7 kWh which is the amount of electric power consumed in the mobile object 40 after it departs from the load dispatching office facility 20. The calculation unit 65 subtracts 7 kWh which is the amount of consumed electric power from the total value of 10 kWh of non-green power amount stored in the mobile object built-in storage battery 42 when the mobile object 40 departs from the load dispatching office facility 20 and 2 kWh which is the generated electric power and calculates 5 kWh of electric power as the amount of non-green power stored in the mobile object built-in storage battery 42 when the mobile object 40 arrives at the provider facility 30. Moreover, the calculation unit 65 calculates 5 kWh, which is the same as when the mobile object 40 departs from the load dispatching office facility 20, as the amount of green power stored in the mobile object built-in storage battery 42 when the mobile object 40 arrives at the provider facility 30, and calculates 10 kWh of electric power as the total amount of electric power of green power and non-green power.

In the example illustrated in FIG. 5, the calculation unit 65 can reflect the amount of electric power generated by the mobile object 40 in calculation of the amount of electric power of the mobile object built-in storage battery 42 by the types of electric power, and thus it is possible to more accurately calculate the amount of electric power.

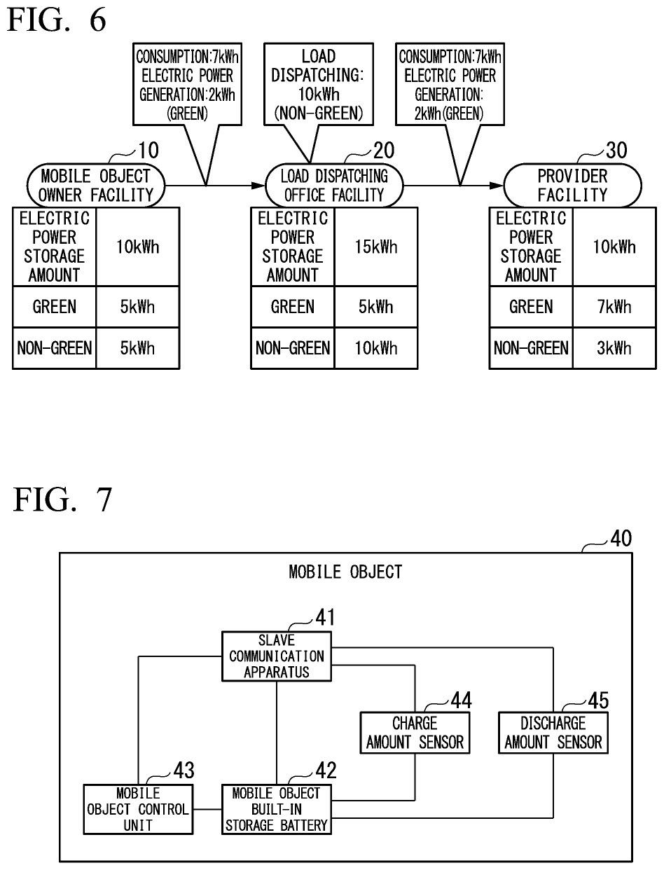

FIG. 6 is a diagram illustrating a fourth example in which the network server apparatus 60 calculates the amount of electric power for each type of electric power. The example illustrated in FIG. 6 is different from the example illustrated in FIG. 5 in that the calculation unit 65 treats electric power generated by the mobile object 40 as green power. The example illustrated in FIG. 6 is the same as the example illustrated in FIG. 5 in the other points.

With respect to the consumed electric power before the mobile object 40 arrives at the load dispatching office facility 20, the calculation unit 65 assumes that 5 kWh of non-green power is preferentially consumed and 2 kWh which is the shortfall therein is consumed from green power. As a result, the calculation unit 65 calculates 5 kWh of green power amount and 10 kWh of non-green power amount, that is, a total of 15 kWh of electric power, as the electric power storage amount of the mobile object built-in storage battery 42 when the mobile object 40 departs from the load dispatching office facility 20.

On the other hand, with respect to the consumed electric power after the mobile object 40 departs from the load dispatching office facility 20, the calculation unit 65 assumes that 7 kWh which is the amount of electric power consumed in the mobile object 40 is all consumed from non-green power. The calculation unit 65 assumes that the mobile object built-in storage battery 42 is charged with 2 kWh which is the amount of electric power generated by the mobile object 40 as green power.

Accordingly, the calculation unit 65 calculates 7 kWh of green power amount and 3 kWh of non-green power amount, that is, a total of 10 kWh of electric power, as the electric power storage amount of the mobile object built-in storage battery 42 when the mobile object 40 arrives at the provider facility 30.

Also in the example illustrated in FIG. 6, the calculation unit 65 can reflect the amount of electric power generated by the mobile object 40 in calculation of the amount of electric power of the mobile object built-in storage battery 42 by the types of electric power, and thus it is possible to more accurately calculate the amount of electric power.

As described above, the mobile object 40 may include a sensor that measures the amount of charging electric power of the mobile object built-in storage battery 42 and a sensor that measures the amount of discharging electric power of the mobile object built-in storage battery 42.

FIG. 7 is a diagram schematically illustrating another example of the configuration of the mobile object 40. In the configuration illustrated in FIG. 7, the mobile object 40 includes a slave communication apparatus 41, a mobile object built-in storage battery 42, a mobile object control unit 43, a charge amount sensor 44, and a discharge amount sensor 45.

The mobile object 40 illustrated in FIG. 7 is different from that illustrated in FIG. 1 in that the charge amount sensor 44 and the discharge amount sensor 45 are provided therein. The mobile object 40 illustrated in FIG. 7 is the same as that illustrated in FIG. 1 in the other points.

The charge amount sensor 44 measures the charge amount of the mobile object built-in storage battery 42. For example, the charge amount sensor 44 may measure an input current of the mobile object built-in storage battery 42, calculate a charging electric power by multiplying the measured current by a voltage, and calculate a time integral of the charging electric power to thereby acquire the amount of charging electric power.

The discharge amount sensor 45 measures the discharge amount of the mobile object built-in storage battery 42. For example, the discharge amount sensor 45 may measure the output current of the mobile object built-in storage battery 42, calculate a discharging electric power by multiplying the measured current by a voltage, and calculate a time integral of the discharging electric power, to thereby acquire the amount of discharging electric power.

Since the mobile object 40 includes the charge amount sensor 44 and the discharge amount sensor 45, it is possible to more accurately check the amount of charging electric power and the amount of discharging electric power of the mobile object built-in storage battery 42. Accordingly, it is also possible to more accurately calculate the amount of electric power stored in the mobile object built-in storage battery 42.

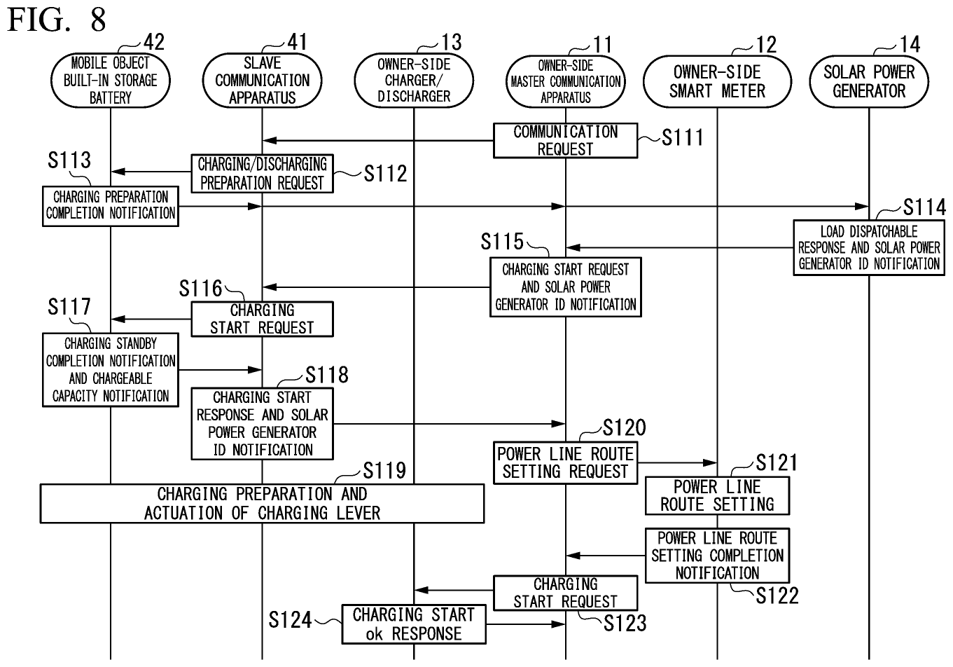

FIG. 8 is a first diagram illustrating an example of a process which is performed by the electric power system 1 when the owner-side charger/discharger 13 charges the mobile object 40 with green energy.

### (Step S111)

The owner-side master communication apparatus 11 requests communication with the slave communication apparatus 41, and the owner-side master communication apparatus 11 and the slave communication apparatus 41 are connected to each other such that communication between the owner-side master communication apparatus 11 and the slave communication apparatus 41 is possible.

### (Step S112)

The slave communication apparatus 41 requests the mobile object built-in storage battery 42 to prepare for charging or discharging. A trigger with which the mobile object built-in storage battery 42 performs charging or discharging is not particularly limited. For example, the mobile object built-in storage battery 42 may perform charging or discharging in accordance with a user's operation. Alternatively, the mobile object built-in storage battery 42 may perform charging or discharging in response to a request from an energy management system such as a home energy management system (HEMS).

### (Step S113)

The mobile object built-in storage battery 42 notifies the slave communication apparatus 41 of charging preparation completion in response to the request for preparation of charging or discharging in Step S112. The slave communication apparatus 41 transmits a charging preparation completion notification from the mobile object built-in storage battery 42 to the solar power generator 14 via the owner-side master communication apparatus 11.

### (Step S114)

The solar power generator 14 returns a load dispatchable notification to the owner-side master communication apparatus 11 in response to the charging preparation completion notification in Step S113. Moreover, the solar power generator 14 notifies the owner-side master communication apparatus 11 of a solar power generator ID which is identification information of the solar power generator 14 itself. For example, the solar power generator 14 may transmit a load dispatchable response signal including the solar power generator ID of the solar power generator 14 itself to the owner-side master communication apparatus 11.

### (Step S115)

The owner-side master communication apparatus 11 receives the load dispatchable response from the solar power generator 14 and requests the mobile object built-in storage battery 42 to start charging. Specifically, the owner-side master communication apparatus 11 transmits a charging start request and the solar power generator ID of the solar power generator 14 to the slave communication apparatus 41. The owner-side master communication apparatus 11 may transmit a charging start request signal including the solar power generator ID of the solar power generator 14 to the slave communication apparatus 41.

### (Step S116)

The slave communication apparatus 41 requests the mobile object built-in storage battery 42 to start charging in response to the charging start request from the owner-side master communication apparatus 11. The slave communication apparatus 41 may transmit the charging start request signal to the mobile object built-in storage battery 42.

### (Step S117)

The mobile object built-in storage battery 42 transmits a notification indicating that transition to a charging standby state has been completed and a chargeable capacity to the slave communication apparatus 41 in response to the charging start request from the slave communication apparatus 41. The mobile object built-in storage battery 42 may transmit a charging standby completion signal including information on the chargeable capacity to the slave communication apparatus 41.

### (Step S118)

The slave communication apparatus 41 receives the notification indicating that transition of the mobile object built-in storage battery 42 to the charging standby state has been completed, transmits a charging start response to the charging start request to the owner-side master communication apparatus 11, and transmits a notification including the solar power generator ID of the solar power generator 14. The slave communication apparatus 41 may transmit a charging start response including the solar power generator ID of the solar power generator 14 to the owner-side master communication apparatus 11.

### (Step S119)

Preparation for charging from the owner-side charger/discharger 13 to the mobile object 40 is performed and a charging lever of the owner-side charger/discharger 13 is actuated. For example, a user may connect a charging connector of the owner-side charger/discharger 13 to a charging inlet of the mobile object 40 and actuate the charging lever.

### (Step S120)

The owner-side master communication apparatus 11 receives the charging start response from the slave communication apparatus 41 and requests the owner-side smart meter 12 to set a power line route. Here, the owner-side master communication apparatus 11 requests the owner-side smart meter 12 to set a power supply path from the solar power generator 14 to the mobile object built-in storage battery 42.

### (Step S121)

The owner-side smart meter 12 sets the power supply path from the solar power generator 14 to the mobile object built-in storage battery 42 in response to the request from the owner-side master communication apparatus 11.

### (Step S122)

The owner-side smart meter 12 notifies the owner-side master communication apparatus 11 that setting of the power line route has been completed.

### (Step S123)

The owner-side master communication apparatus 11 requests the owner-side charger/discharger 13 to start charging.

### (Step S124)

The owner-side charger/discharger 13 returns a notification indicating that charging can be started in response to the charging start request from the owner-side master communication apparatus 11.

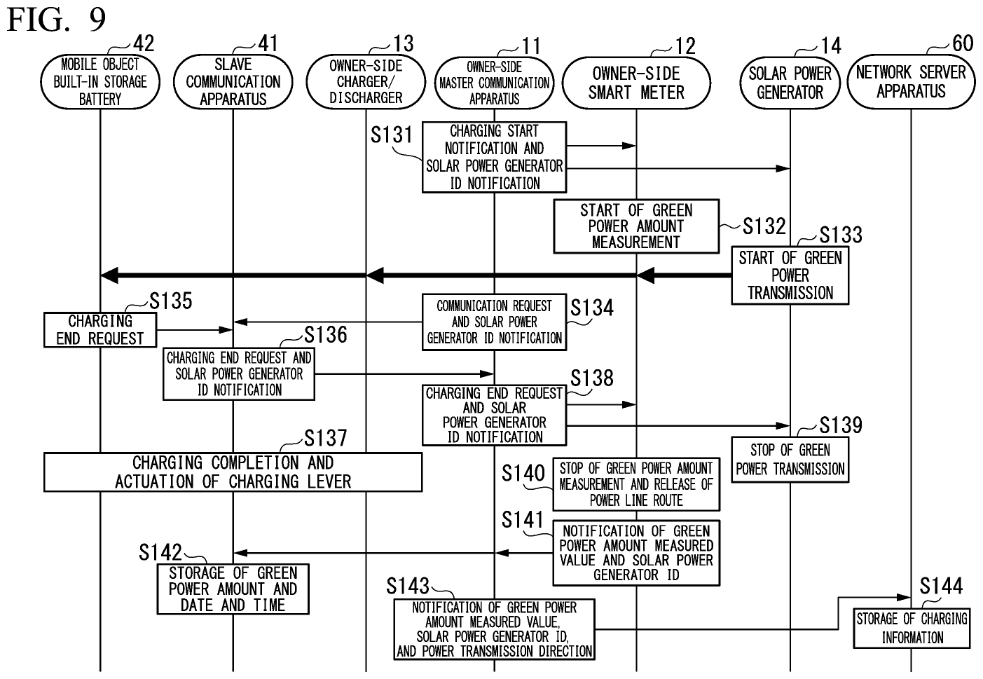

After the process illustrated in FIG. 8 has been performed, the processing of the electric power system 1 proceeds to the process illustrated in FIG. 9.

FIG. 9 is a second diagram illustrating an example of a process which is performed by the electric power system 1 when the owner-side charger/discharger 13 charges the mobile object 40 with green energy.

### (Step S131)

The owner-side master communication apparatus 11 transmits a charging start notification and the solar power generator ID of the solar power generator 14 to the owner-side smart meter 12 and the solar power generator 14 in response to a response indicating that charging can be started from the owner-side charger/discharger 13 in Step S124 of FIG. 8.

### (Step S132)

The owner-side smart meter 12 starts measurement of the amount of green power in response to the charging start notification from the owner-side master communication apparatus 11. The owner-side smart meter 12 may separately measure the green power and the non-green power depending on whether or not notification of the solar power generator ID has been transmitted from the owner-side master communication apparatus 11. Alternatively, the owner-side smart meter 12 may measure the amount of electric power without distinguishing the green power and the non-green power, and an apparatus other than the owner-side smart meter 12, such as the network server apparatus 60 or the owner-side master communication apparatus 11, may distinguish the green power and the non-green power.

The amount of green power is also referred to as a green power amount. The amount of non-green power is also referred to as a non-green power amount.

### (Step S133)

The solar power generator 14 starts transmission of green power to the mobile object built-in storage battery 42.

### (Step S134)

When communication between the owner-side master communication apparatus 11 and the slave communication apparatus 41 has ended, the owner-side master communication apparatus 11 requests communication with the slave communication apparatus 41 for the purpose of a process of ending charging of the mobile object built-in storage battery 42, and the owner-side master communication apparatus 11 and the slave communication apparatus 41 are connected such that communication between the owner-side master communication apparatus 11 and the slave communication apparatus 41 is possible. Moreover, the owner-side master communication apparatus 11 notifies the slave communication apparatus 41 of the solar power generator ID of the solar power generator 14.

### (Step S135)

When the charging amount of the mobile object built-in storage battery 42 reaches a scheduled charging amount such as the amount of fully charged electric power, the mobile object built-in storage battery 42 requests the slave communication apparatus 41 to end the charging.

### (Step S136)

The slave communication apparatus 41 forwards a charging end request from the mobile object built-in storage battery 42 to the owner-side master communication apparatus 11. In addition, the slave communication apparatus 41 notifies the owner-side master communication apparatus 11 of the solar power generator ID of the solar power generator 14. The slave communication apparatus 41 may transmit a charging end request signal including the solar power generator ID of the solar power generator 14 to the owner-side master communication apparatus 11.

### (Step S137)

When charging from the owner-side charger/discharger 13 to the mobile object 40 has been completed, the charging lever of the owner-side charger/discharger 13 is actuated. For example, the user may return the charging lever of the owner-side charger/discharger 13 and detach the charging connector of the owner-side charger/discharger 13 from the charging inlet of the mobile object 40.

### (Step S138)

The owner-side master communication apparatus 11 forwards the charging end request and the solar power generator ID of the solar power generator 14 from the slave communication apparatus 41 to the owner-side smart meter 12 and the solar power generator 14.

### (Step S139)

The solar power generator 14 stops transmission of green power in response to the charging end request from the owner-side master communication apparatus 11.

### (Step S140)

The owner-side smart meter 12 stops measurement of the green power amount and release the power line route in response to the charging end request from the owner-side master communication apparatus 11.

### (Step S141)

The owner-side smart meter 12 notifies the owner-side master communication apparatus 11 of the green power amount measured value and the solar power generator ID of the solar power generator 14. The owner-side master communication apparatus 11 forwards the green power amount measured value and the solar power generator ID of the solar power generator 14 to the slave communication apparatus 41.

### (Step S142)

The slave communication apparatus 41 stores the transmitted green power amount as the amount of charging electric power to the mobile object built-in storage battery 42 in correlation with charging time (date and time) information.

### (Step S143)

The owner-side master communication apparatus 11 notifies the network server apparatus 60 of the green power amount measured value, the solar power generator ID of the solar power generator 14, and a power transmission direction. Here, the power transmission direction is charging of the mobile object built-in storage battery 42.

### (Step S144)

The network server apparatus 60 stores the information transmitted from the owner-side master communication apparatus 11. For example, the network server apparatus 60 stores the green power amount measured value, the solar power generator ID of the solar power generator 14, and the power transmission direction in correlation with the charging time information. The network server apparatus 60 may use a time at which a notification from the owner-side master communication apparatus 11 is received as a charging time. Alternatively, the network server apparatus 60 may acquire the charging time information from the owner-side master communication apparatus 11.

A prospective purchaser of green power can check that the mobile object built-in storage battery 42 is charged with green power by acquiring information stored in the slave communication apparatus 41 and inquiring of the network server apparatus 60 at the time of purchasing green power from the mobile object 40. Moreover, the amount of charging electric power stored in the slave communication apparatus 41 and the network server apparatus 60 can be used to calculate a green power amount out of the amount of electric power stored in the mobile object built-in storage battery 42.

The network server apparatus 60 may store one of identification information of the mobile object 40, identification information of the mobile object built-in storage battery 42, the amount of electric power stored in the mobile object built-in storage battery 42, details of green power and non-green power out of the amount of electric power stored in the mobile object built-in storage battery 42 or a combination thereof in addition to the green power amount measured value, the solar power generator ID of the solar power generator 14, the power transmission direction, and the charging time information.

After Step S144, the electric power system 1 ends the process when the owner-side charger/discharger 13 charges the mobile object 40 with green energy.

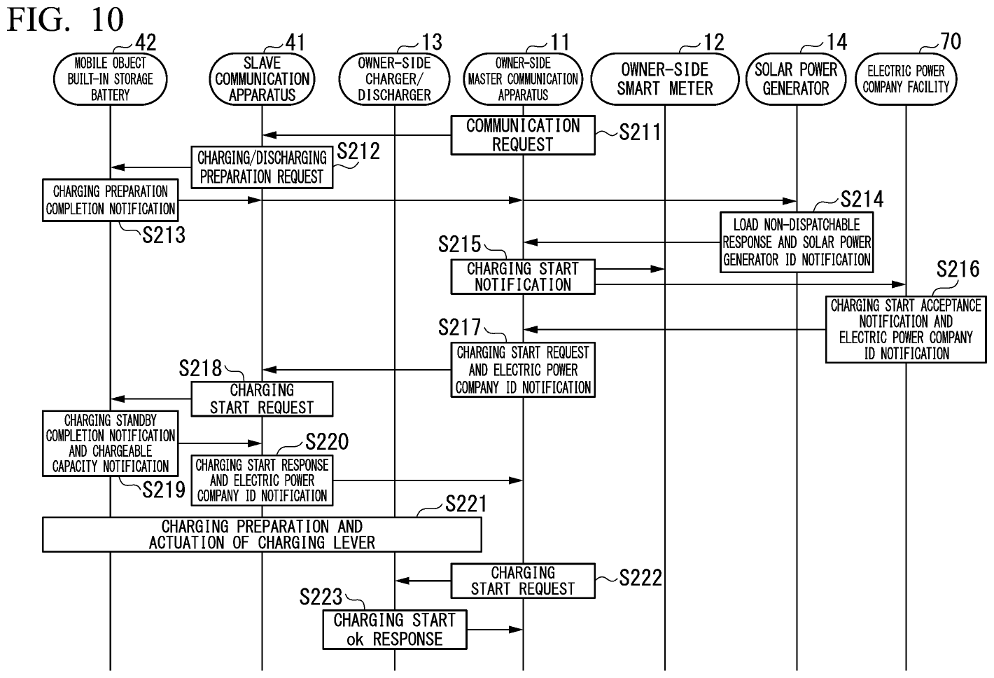

FIG. 10 is a first diagram illustrating an example of a process which is performed by the electric power system 1 when the owner-side charger/discharger 13 charges the mobile object 40 with non-green energy.

Steps S211 to S213 are the same as Steps S111 to S113 in FIG. 8.

### (Step S214)

The solar power generator 14 returns a non-load dispatchable notification to the owner-side master communication apparatus 11 in response to the charging preparation completion notification in Step S213. Moreover, the solar power generator 14 notifies the owner-side master communication apparatus 11 of the solar power generator ID which is identification information of the solar power generator 14 itself. For example, the solar power generator 14 may transmit a non-load dispatchable response signal including the solar power generator ID of the solar power generator 14 itself to the owner-side master communication apparatus 11.

### (Step S215)

The owner-side master communication apparatus 11 receives the non-load dispatchable response from the solar power generator 14 and notifies the owner-side smart meter 12 and the electric power company facility 70 of charging start. It should be noted that the electric power company facility 70 may be a facility of a power generation provided other than an electric power company, which is connected via a power line (e.g., the electric power grid 90) with a power supply contract, as well as a facility of the electric power company.

Accordingly, the owner-side master communication apparatus 11 tries to charge the mobile object built-in storage battery 42 with commercial electric power.

### (Step S216)

The electric power company facility 70 transmits a notification indicating that charging start is accepted and an electric power company ID which is identification information of the electric power company facility 70 itself to the owner-side master communication apparatus 11 in response to the charging start notification from the owner-side master communication apparatus 11. Here, the electric power company ID is also referred to as an electric power company ID of the electric power company facility 70.

### (Step S217)

The owner-side master communication apparatus 11 receives a charging start acceptance notification from the electric power company facility 70, requests the slave communication apparatus 41 to start charging, and notifies the slave communication apparatus 41 of the electric power company ID of the electric power company facility 70.

Steps S218 and S219 are the same as Steps S116 and 117 in FIG. 8.

### (Step S220)

The slave communication apparatus 41 receives a notification indicating that transition of the mobile object built-in storage battery 42 to the charging standby state has been completed, returns a charging start response in response to the charging start request to the owner-side master communication apparatus 11, and transmits the electric power company ID of the electric power company facility 70. The slave communication apparatus 41 may transmit a charging start response including the electric power company ID of the electric power company facility 70 to the owner-side master communication apparatus 11.

Step S221 is the same as Step S119 in FIG. 8. Steps S222 and S223 are the same as Steps S123 and S124 in FIG. 8.

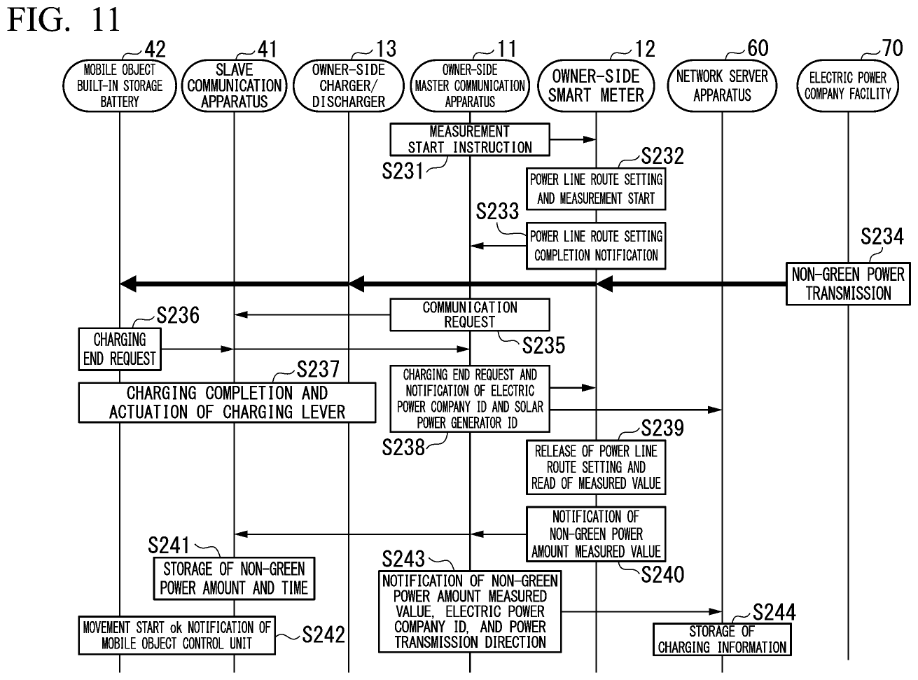

After the process illustrated in FIG. 10 has been performed, the process of the electric power system 1 proceeds to the process illustrated in FIG. 11.

FIG. 11 is a second diagram illustrating an example of a process which is performed by the electric power system 1 when the owner-side charger/discharger 13 charges the mobile object 40 with non-green energy.

### (Step S231)

The owner-side master communication apparatus 11 instructs the owner-side smart meter 12 to start measurement of non-green power.

### (Step S232)

The owner-side smart meter 12 sets a power line route and starts measurement of the non-green power amount in accordance with the instruction from the owner-side master communication apparatus 11. Here, the owner-side smart meter 12 sets a power supply path of commercial electric power, which is supplied from the electric power company facility 70 via the electric power grid 90, to the mobile object built-in storage battery 42.

### (Step S233)

The owner-side smart meter 12 notifies the owner-side master communication apparatus 11 that setting of the power line route has been completed.

### (Step S234)

The commercial electric power supplied from the electric power company facility 70 is supplied to the mobile object built-in storage battery 42.

### (Step S235)

When communication between the owner-side master communication apparatus 11 and the slave communication apparatus 41 has ended, the owner-side master communication apparatus 11 requests communication with the slave communication apparatus 41 for the purpose of a process of ending charging of the mobile object built-in storage battery 42, and the owner-side master communication apparatus 11 and the slave communication apparatus 41 are connected such that communication between the owner-side master communication apparatus 11 and the slave communication apparatus 41 is possible.

### (Step S236)

When the charge amount of the mobile object built-in storage battery 42 reaches a scheduled charging amount such as the amount of fully charged electric power, the mobile object built-in storage battery 42 requests the slave communication apparatus 41 to end the charging. The slave communication apparatus 41 forwards a charging end request from the mobile object built-in storage battery 42 to the owner-side master communication apparatus 11.

Step S237 is the same as Step S137 in FIG. 9.

### (Step S238)

The owner-side master communication apparatus 11 forwards the charging end request from the slave communication apparatus 41 to the owner-side smart meter 12 and the network server apparatus 60. In addition, the owner-side master communication apparatus 11 notifies the owner-side smart meter 12 and the network server apparatus 60 of the solar power generator ID of the solar power generator 14 and the electric power company ID of the electric power company facility 70. The owner-side master communication apparatus 11 may transmit a charging end request signal including the solar power generator ID of the solar power generator 14 and the electric power company ID of the electric power company facility 70 to the owner-side smart meter 12 and the network server apparatus 60.

### (Step S239)

The owner-side smart meter 12 receives the charging end request from the owner-side master communication apparatus 11, releases setting of the power line route, and reads a non-green power amount measured value.

### (Step S240)

The owner-side smart meter 12 notifies the owner-side master communication apparatus 11 of the non-green power amount measured value. The owner-side master communication apparatus 11 forwards the non-green power amount measured value to the slave communication apparatus 41.

### (Step S241)

The slave communication apparatus 41 stores the transmitted non-green power amount measured value as the amount of charging electric power to the mobile object built-in storage battery 42 in correlation with the charging time information.

### (Step S242)

The slave communication apparatus 41 instructs the mobile object control unit 43 that the mobile object 40 is allowed to move.

### (Step S243)

The owner-side master communication apparatus 11 notifies the network server apparatus 60 of the non-green power amount measured value, the electric power company ID of the electric power company facility 70, and the power transmission direction. Here, the power transmission direction is charging of the mobile object built-in storage battery 42.

### (Step S244)

The network server apparatus 60 stores the information transmitted from the owner-side master communication apparatus 11. For example, the network server apparatus 60 stores the non-green power amount measured value, the electric power company ID of the electric power company facility 70, and the power transmission direction in correlation with the charging time information. The network server apparatus 60 may use a time at which the notification from the owner-side master communication apparatus 11 is received as the charging time. Alternatively, the network server apparatus 60 may acquire the charging time information from the owner-side master communication apparatus 11.

The information stored in the network server apparatus 60 can be used to check the charging/discharging information of the mobile object built-in storage battery 42 stored in the slave communication apparatus 41. For example, it is possible to check whether electric power with which the mobile object built-in storage battery 42 has been charged is green power or non-green power using the information stored in the network server apparatus 60.

Moreover, the information stored in the slave communication apparatus 41 and the network server apparatus 60 can be used to calculate details of the green power amount and the non-green power amount out of the amount of electric power stored in the mobile object built-in storage battery 42.

The network server apparatus 60 may store one of the identification information of the mobile object 40, the identification information of the mobile object built-in storage battery 42, the amount of electric power stored in the mobile object built-in storage battery 42, details of the green power and the non-green power out of the amount of electric power stored in the mobile object built-in storage battery 42 or a combination thereof in addition to the non-green power amount measured value, the electric power company ID of the electric power company facility 70, the power transmission direction, and the charging time information.

After Step S244, the electric power system 1 ends the process when the owner-side charger/discharger 13 charges the mobile object 40 with non-green energy.

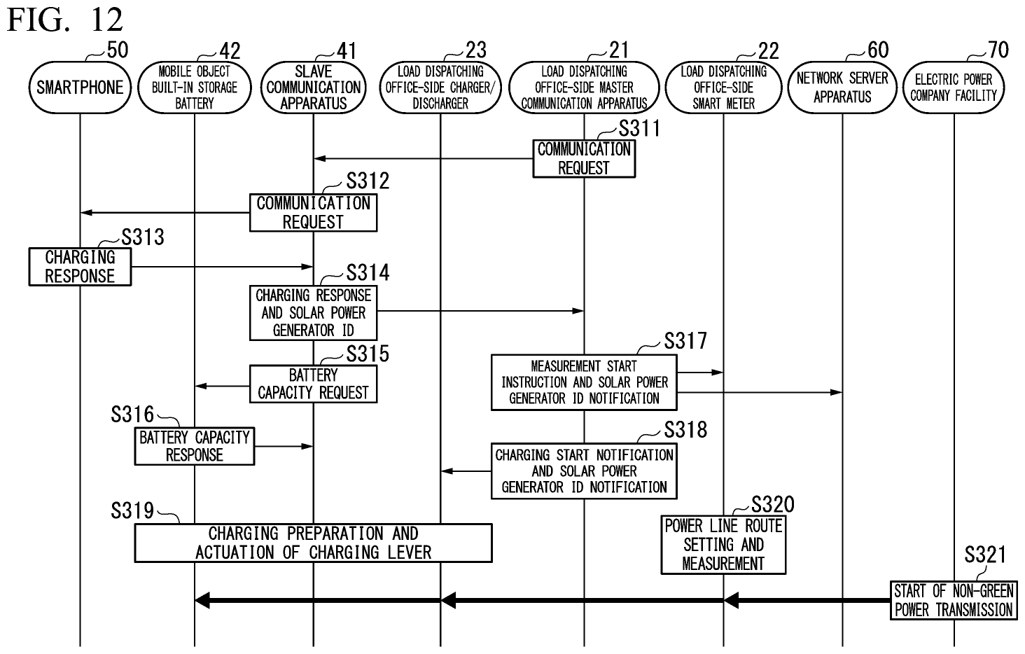

FIG. 12 is a first diagram illustrating an example of a process which is performed by the electric power system 1 when the load dispatching office-side charger/discharger 23 charges the mobile object 40 with non-green energy.

### (Step S311)

The load dispatching office-side master communication apparatus 21 requests communication with the slave communication apparatus 41, and the load dispatching office-side master communication apparatus 21 and the slave communication apparatus 41 are connected such that communication between the load dispatching office-side master communication apparatus 21 and the slave communication apparatus 41 is possible.

### (Step S312)

The slave communication apparatus 41 requests communication with the smartphone 50, and the slave communication apparatus 41 and the smartphone 50 are connected such that communication between the slave communication apparatus 41 and the smartphone 50 is possible.

### (Step S313)

The smartphone 50 returns a notification indicating that charging of the mobile object built-in storage battery 42 is performed to the slave communication apparatus 41. For example, the smartphone 50 transmits, to the slave communication apparatus 41, a notification indicating that charging of the mobile object built-in storage battery 42 is performed and the amount of charging electric power in accordance with a user's operation. Instead of the smartphone 50, the mobile object built-in storage battery 42 or the mobile object control unit 43 may transmit, to the slave communication apparatus 41, the notification indicating that the charging is performed and the amount of charging electric power.

### (Step S314)

The slave communication apparatus 41 forwards the response indicating that charging of the mobile object built-in storage battery 42 is performed from the smartphone 50 to the load dispatching office-side master communication apparatus 21. In addition, the slave communication apparatus 41 notifies the load dispatching office-side master communication apparatus 21 of the solar power generator ID of the solar power generator 14. For example, the slave communication apparatus 41 may store the solar power generator ID of the solar power generator 14 at the time of receiving of green power from the solar power generator 14 in the mobile object owner facility 10 and notify the load dispatching office-side master communication apparatus 21 of the solar power generator ID of the solar power generator 14 at the time of receiving electric power in the load dispatching office facility 20.

The solar power generator ID of the solar power generator 14 can be used as a search key for inquiring of the network server apparatus 60 about the charging information of the mobile object built-in storage battery 42.

### (Step S315)

The slave communication apparatus 41 inquires of the mobile object built-in storage battery 42 about a battery capacity (the amount of electric power in a fully charged state) of the mobile object built-in storage battery 42.

### (Step S316)

The mobile object built-in storage battery 42 returns the battery capacity.

### (Step S317)

The load dispatching office-side master communication apparatus 21 transmits a measurement start instruction to the load dispatching office-side smart meter 22 and the network server apparatus 60 in response to the response indicating that charging is performed from the slave communication apparatus 41. In addition, the load dispatching office-side master communication apparatus 21 notifies the load dispatching office-side smart meter 22 and the network server apparatus 60 of the solar power generator ID of the solar power generator 14.

### (Step S318)

The load dispatching office-side master communication apparatus 21 notifies the load dispatching office-side charger/discharger 23 of the charging start notification and the solar power generator ID of the solar power generator 14.

### (Step S319)

Preparation for charging from the load dispatching office-side charger/discharger 23 to the mobile object 40 is performed, and a charging lever of the load dispatching office-side charger/discharger 23 is actuated. For example, a user may connect a charging connector of the load dispatching office-side charger/discharger 23 to the charging inlet of the mobile object 40 and operate the charging lever.

### (Step S320)

The load dispatching office-side smart meter 22 sets a power line route and starts measurement of non-green power. The load dispatching office-side smart meter 22 sets the power line route and starts measurement of the non-green power amount in accordance with the measurement start instruction from the load dispatching office-side master communication apparatus 21. Here, the load dispatching office-side smart meter 22 sets the power line route of commercial electric power, which is supplied from the electric power company facility 70 via the electric power grid 90, to the mobile object built-in storage battery 42.

### (Step S321)

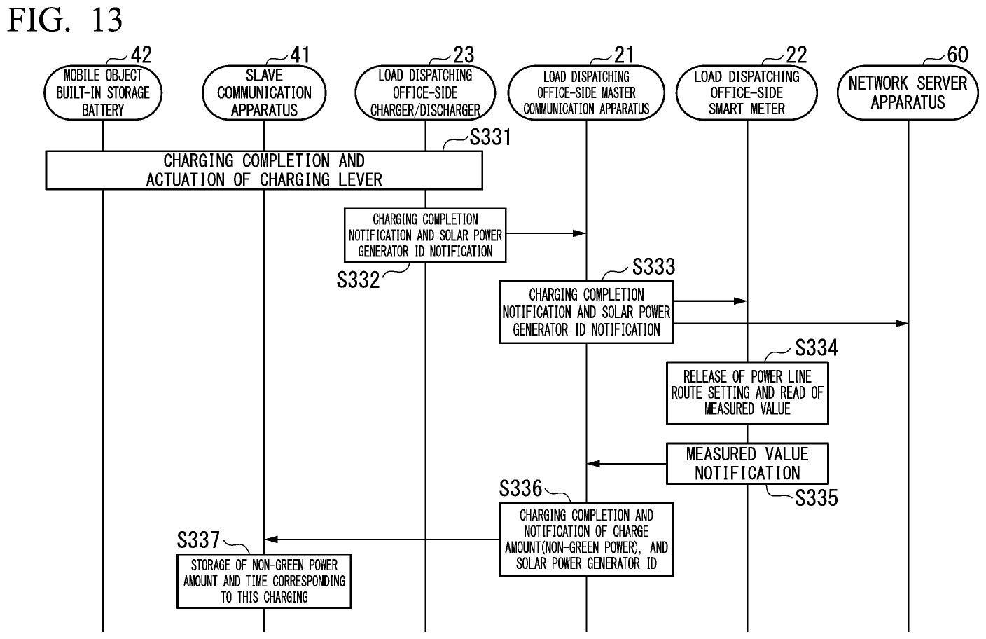

The mobile object built-in storage battery 42 is charged with the commercial electric power supplied from the electric power company facility 70. After the process illustrated in FIG. 12 has been performed, the process of the electric power system 1 proceeds to the process illustrated in FIG. 13.

FIG. 13 is a second diagram illustrating an example of a process which is performed by the electric power system 1 when the load dispatching office-side charger/discharger 23 charges the mobile object 40 with non-green energy.

### (Step S331)

When charging of the mobile object 40 from the load dispatching office-side charger/discharger 23 is completed, the charging lever of the load dispatching office-side charger/discharger 23 is actuated. For example, a user may return the charging lever of the load dispatching office-side charger/discharger 23 and detach the charging connector of the load dispatching office-side charger/discharger 23 from the charging inlet of the mobile object 40.

### (Step S332)

The load dispatching office-side charger/discharger 23 receives the charging completion notification in Step S331 and transmits the load dispatching office-side master communication apparatus 21 of the charging completion notification and the solar power generator ID of the solar power generator 14.

### (Step S333)

The load dispatching office-side master communication apparatus 21 transmits the charging completion notification and the solar power generator ID of the solar power generator 14 from the load dispatching office-side charger/discharger 23 to the load dispatching office-side smart meter 22 and the network server apparatus 60.

### (Step S334)

The load dispatching office-side smart meter 22 releases the power line route and reads the non-green power amount measured value in response to the charging completion notification from the load dispatching office-side master communication apparatus 21.

### (Step S335)

The load dispatching office-side smart meter 22 notifies the load dispatching office-side master communication apparatus 21 of the read measured value.

### (Step S336)

The load dispatching office-side master communication apparatus 21 transmits the slave communication apparatus 41 of the charging completion notification, the non-green power amount measured value, and the solar power generator ID of the solar power generator 14.

### (Step S337)

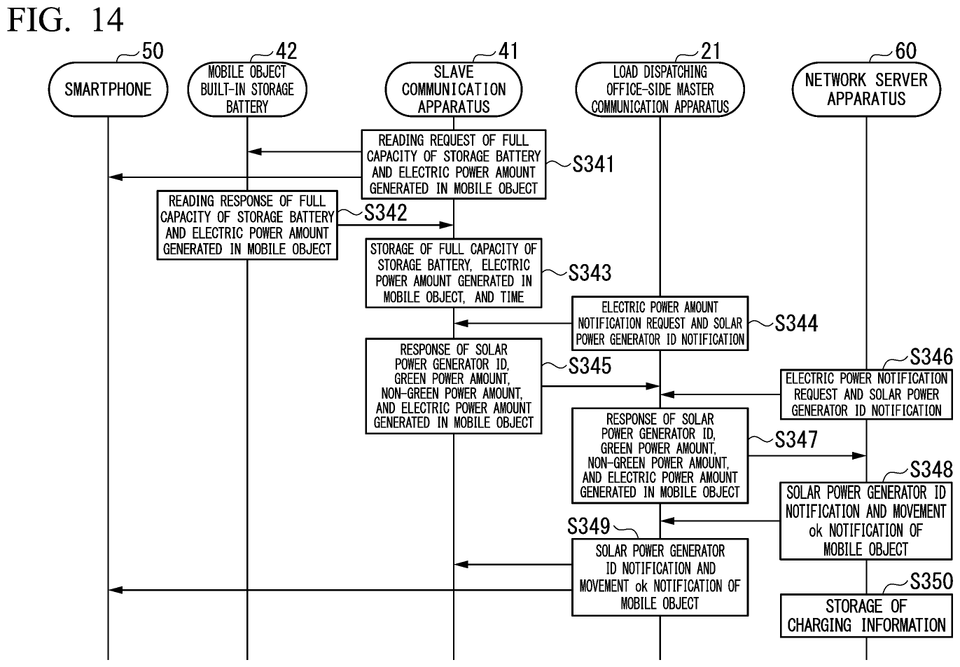

The slave communication apparatus 41 stores the non-green power amount corresponding to this charging as the amount of charging electric power to the mobile object built-in storage battery 42 in correlation with the charging time information. After the process illustrated in FIG. 13 has been performed, the process of the electric power system 1 proceeds to the process illustrated in FIG. 14.

FIG. 14 is a third diagram illustrating an example of a process which is performed by the electric power system 1 when the load dispatching office-side charger/discharger 23 charges the mobile object 40 with non-green energy.

### (Step S341)

The slave communication apparatus 41 transmits a request for reading the full capacity of the mobile object built-in storage battery 42 and the amount of electric power generated by the mobile object 40 itself to the smartphone 50 and the mobile object built-in storage battery 42.

### (Step S342)

The mobile object built-in storage battery 42 reads the full capacity (the amount of electric power in a fully charged state) of the mobile object built-in storage battery 42 and the amount of electric power generated by the mobile object 40 and returns them as a response. For example, the mobile object built-in storage battery 42 periodically measures and stores the amount of electric power in the fully charged state. Moreover, the mobile object 40 includes a sensor that measures the amount of electric power generated by the mobile object 40, and the mobile object built-in storage battery 42 stores the value of the amount of electric power generated by the mobile object 40 which is measured by the sensor. The mobile object 40 may include a power generator and the sensor may measure the amount of electric power generated by the power generator. Alternatively, regenerative energy when the mobile object 40 stops may be measured by the sensor.

### (Step S343)

The slave communication apparatus 41 stores the full capacity of the mobile object built-in storage battery 42 and the amount of electric power generated by the mobile object 40 in correlation with the time.

### (Step S344)

The load dispatching office-side master communication apparatus 21 requests the slave communication apparatus 41 to notify of the amount of electric power. In addition, the load dispatching office-side master communication apparatus 21 notifies the slave communication apparatus 41 of the solar power generator ID of the solar power generator 14.

### (Step S345)

The slave communication apparatus 41 returns the solar power generator ID of the solar power generator 14, the green power amount, the non-green power amount, and the amount of electric power generated by the mobile object 40 to the load dispatching office-side master communication apparatus 21.

The slave communication apparatus 41 may notify the load dispatching office-side master communication apparatus 21 of charging/discharging records such as the amount of charged green power stored in Step S142 in FIG. 9, the amount of charged non-green power stored in Step S241 in FIG. 11, and the amount of charged non-green power stored in Step S337 in FIG. 13. Alternatively, the slave communication apparatus 41 may calculate a residual amount of charged electric power by subtracting the total amount of discharged electric power from the total amount of charged electric power on the basis of the charging/discharging records for each of green power and non-green power and notify the load dispatching office-side master communication apparatus 21 of the calculated residual amount of charged electric power.

### (Step S346)

The network server apparatus 60 requests the load dispatching office-side master communication apparatus 21 to notify the amount of electric power. In addition, the network server apparatus 60 notifies the load dispatching office-side master communication apparatus 21 of the solar power generator ID of the solar power generator 14.

### (Step S347)

The load dispatching office-side master communication apparatus 21 returns the solar power generator ID of the solar power generator 14, the green power amount, the non-green power amount, and the amount of electric power generated by the mobile object 40 to the network server apparatus 60. The load dispatching office-side master communication apparatus 21 may store the information acquired in Step S345, and read the stored information and return the read information to the network server apparatus 60 when a request from the network server apparatus 60 is received.

### (Step S348)

The network server apparatus 60 transmits the load dispatching office-side master communication apparatus 21 of the solar power generator ID of the solar power generator 14 and a notification indicating that the mobile object 40 is allowed to move.

### (Step S349)

The load dispatching office-side master communication apparatus 21 forwards the solar power generator ID of the solar power generator 14 and the notification indicating that the mobile object 40 is allowed move to the slave communication apparatus 41 and the smartphone 50.

### (Step S350)

The network server apparatus 60 stores the information transmitted from the load dispatching office-side master communication apparatus 21. For example, the network server apparatus 60 stores the non-green power amount measured value, the solar power generator ID of the solar power generator 14, and the power transmission direction in correlation with the charging time information. The network server apparatus 60 may use the time at which the notification from the load dispatching office-side master communication apparatus 21 has been received as the charging time. Alternatively, the network server apparatus 60 may acquire the charging time information from the load dispatching office-side master communication apparatus 21.

The information stored in the network server apparatus 60 can be used to check the charging/discharging information of the mobile object built-in storage battery 42 stored in the slave communication apparatus 41. For example, it is possible to check whether the electric power with which the mobile object built-in storage battery 42 is charged is green power or non-green power using the information stored in the network server apparatus 60.

Moreover, the information stored in the slave communication apparatus 41 and the network server apparatus 60 can be used to calculate details of the green power amount and the non-green power amount out of the amount of electric power stored in the mobile object built-in storage battery 42.

The network server apparatus 60 may store one of the identification information of the mobile object 40, the identification information of the mobile object built-in storage battery 42, the amount of electric power stored in the mobile object built-in storage battery 42, and details of the green power and the non-green power out of the amount of electric power stored in the mobile object built-in storage battery 42 or a combination thereof in addition to the non-green power amount measured value, the solar power generator ID of the solar power generator 14, the power transmission direction, and the charging time information.

After Step S350, the electric power system 1 ends the process when the load dispatching office-side charger/discharger 23 charges the mobile object 40 with non-green energy.

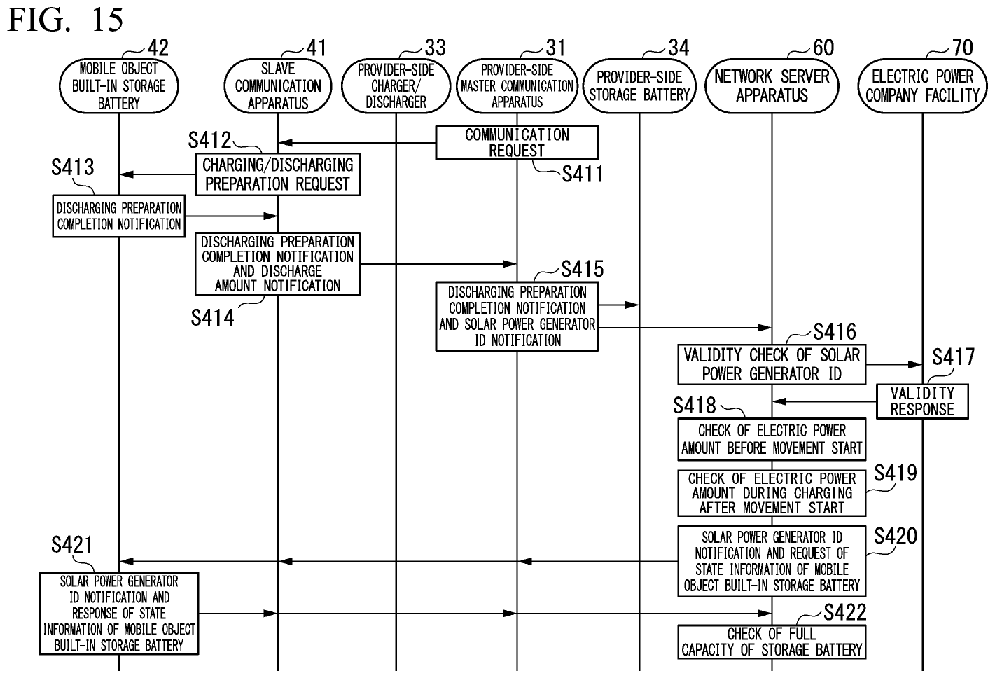

FIG. 15 is a first diagram illustrating an example of a process which is performed by the electric power system 1 when the mobile object 40 discharges green energy to the provider-side charger/discharger 33.

### (Step S411)

The provider-side master communication apparatus 31 requests communication with the slave communication apparatus 41, and the provider-side master communication apparatus 31 and the slave communication apparatus 41 are connected such that communication between the provider-side master communication apparatus 31 and the slave communication apparatus 41 is possible.

### (Step S412)

The slave communication apparatus 41 requests the mobile object built-in storage battery 42 to prepare for charging or discharging.

### (Step S413)

The mobile object built-in storage battery 42 notifies the slave communication apparatus 41 that preparation for discharging has been completed in response to the request for preparation for charging or discharging in Step S412.

### (Step S414)

The slave communication apparatus 41 transmits the provider-side master communication apparatus 31 of a discharging preparation completion notification and the amount of discharging electric power. The slave communication apparatus 41 may transmit a discharging preparation completion signal including information of the amount of discharging electric power to the provider-side master communication apparatus 31.

### (Step S415)

The provider-side master communication apparatus 31 notifies the provider-side storage battery 34 and the network server apparatus 60 of the discharging preparation completion and the solar power generator ID of the solar power generator 14. The provider-side master communication apparatus 31 may transmit a discharging preparation completion signal including the solar power generator ID of the solar power generator 14 to the provider-side storage battery 34 and the network server apparatus 60.

### (Step S416)

The network server apparatus 60 inquires of the electric power company facility 70 about validity of the solar power generator ID of the solar power generator 14.

### (Step S417)

The electric power company facility 70 returns validity of the solar power generator ID of the solar power generator 14 to the network server apparatus 60. In the example illustrated in FIG. 15, a notification indicating that the solar power generator ID of the solar power generator 14 is valid is returned to the network server apparatus 60.

### (Step S418)

The network server apparatus 60 checks the amount of electric power stored in the mobile object built-in storage battery 42 in the mobile object owner facility 10.

For example, the network server apparatus 60 reads a green power amount a₀ and a non-green power amount b₀ with which the mobile object built-in storage battery 42 is charged in the mobile object owner facility 10, a full capacity X of the mobile object built-in storage battery 42, and a charging date and time to using the solar power generator ID of the solar power generator 14 as a search key. Then, the network server apparatus 60 checks whether X≥a₀+b₀ is satisfied.

That is, the network server apparatus 60 calculates the green power amount a₀ and the non-green power amount b₀ out of the amount of electric power stored in the mobile object built-in storage battery 42 when the mobile object 40 is located in the mobile object owner facility 10 on the basis of history information of the amount of electric power of the mobile object built-in storage battery 42. Then, the network server apparatus 60 checks whether the total value of the green power amount a₀ and the non-green power amount b₀ is equal to or less than the full capacity X of the mobile object built-in storage battery 42 and the mobile object built-in storage battery 42 is chargeable.

### (Step S419)

The network server apparatus 60 checks the amount of electric power of the mobile object built-in storage battery 42 after the mobile object 40 has moved from the mobile object owner facility 10.

For example, after the time at which the mobile object 40 has departed from the mobile object owner facility 10, the network server apparatus 60 reads a green power amount a₁ and a non-green power amount b₁ with which the mobile object built-in storage battery 42 is charged, a full capacity X₁, and a charging time t₁ in the load dispatching office facility 20 using the solar power generator ID of the solar power generator 14 as a search key. In the example illustrated in FIG. 1, the network server apparatus 60 reads the green power amount a₁ and the non-green power amount b₁ with which the mobile object built-in storage battery 42 is charged in the load dispatching office facility 20, the full capacity X₁ of the mobile object built-in storage battery 42 at that time, and the charging time t₁ which is that time.

Then, the network server apparatus 60 checks whether X≥X₁ is satisfied. That is, the full capacity of the mobile object built-in storage battery 42 is thought to decrease with the elapsed time, and the network server apparatus 60 checks this point. When X<X₁ is satisfied, accuracy of information on the full capacity of the mobile object built-in storage battery 42 is thought to be relatively low.

### (Step S420)

The network server apparatus 60 notifies the mobile object built-in storage battery 42 of the solar power generator ID of the solar power generator 14 via the provider-side master communication apparatus 31 and the slave communication apparatus 41 and requests state information of the mobile object built-in storage battery 42. Specifically, the network server apparatus 60 requests the mobile object built-in storage battery 42 to transmit the electric power storage amount Y and a full capacity X₂ of the mobile object built-in storage battery 42 and the amount of electric power s generated by the mobile object 40 itself at a current time t₂.

### (Step S421)

The mobile object built-in storage battery 42 returns the state information of the mobile object built-in storage battery 42 in response to the request from the network server apparatus 60.

For example, as described above, the mobile object built-in storage battery 42 periodically measures and stores the amount of electric power in a fully charged state. Moreover, the mobile object 40 includes a sensor that measures the amount of electric power generated by the mobile object 40, and the mobile object built-in storage battery 42 stores a measured value of the amount of electric power generated in the mobile object 40 which is measured by the sensor. The mobile object 40 may include a power generator and the sensor may measure the amount of electric power generated by the power generator. Alternatively, regenerative energy when the mobile object 40 stops may be measured using the sensor.

As for the electric power storage amount Y of the mobile object built-in storage battery 42, the mobile object 40 may include a charge amount sensor 44 and a discharge amount sensor 45, measure the amount of charging electric power to the mobile object built-in storage battery 42 and the amount of discharging electric power from the mobile object built-in storage battery 42, and calculate the electric power storage amount on the basis of the amount of charging electric power and the amount of discharged electric power.

### (Step S422)

The network server apparatus 60 checks the full capacity of the mobile object built-in storage battery 42. Specifically, the network server apparatus 60 checks whether X₁≥X₂ is satisfied and whether the full capacity of the mobile object built-in storage battery 42 decreases with the elapse of time in addition to check of X≥X₁ in Step S419.

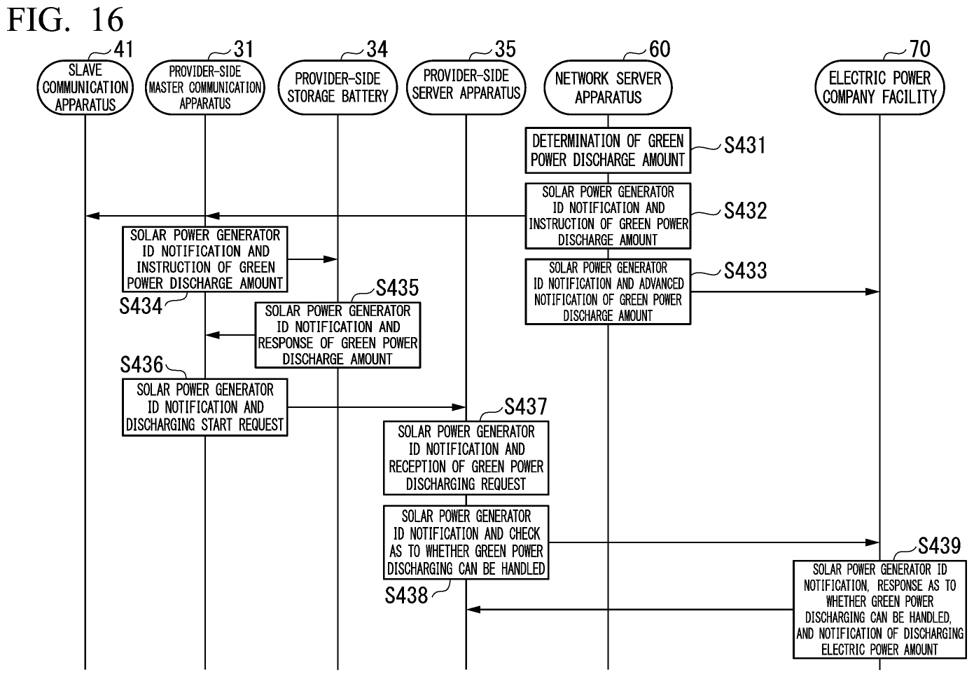

After the process illustrated in FIG. 15 has been performed, the process of the electric power system 1 proceeds to the process illustrated in FIG. 16.

FIG. 16 is a second diagram illustrating an example of a process which is performed by the electric power system 1 when the mobile object 40 discharges green energy to the provider-side charger/discharger 33.

### (Step S431)

The network server apparatus 60 determines the amount of green power discharged from the mobile object built-in storage battery 42 to the provider-side storage battery 34.

### (Step S432)

The network server apparatus 60 notifies the provider-side master communication apparatus 31 of the solar power generator ID of the solar power generator 14 and instructs the discharge amount of green power from the mobile object built-in storage battery 42. The provider-side master communication apparatus 31 forwards the solar power generator ID of the solar power generator 14 and the instruction of the discharge amount of green power to the slave communication apparatus 41.

### (Step S433)

The network server apparatus 60 notifies the electric power company facility 70 of the solar power generator ID of the solar power generator 14 and of the discharge amount of green power in advance.

### (Step S434)

The provider-side master communication apparatus 31 forwards the notification of the solar power generator ID of the solar power generator 14 and the instruction of the discharge amount of green power to the provider-side storage battery 34.

### (Step S435)

The provider-side storage battery 34 notifies the provider-side master communication apparatus 31 of the solar power generator ID of the solar power generator 14 and responds to the instruction of the discharge amount of green power. Here, the provider-side storage battery 34 determines that the instructed amount of electric power is acceptable and notifies the provider-side master communication apparatus 31 of a notification indicating that the instructed amount of electric power is acceptable.

### (Step S436)

The provider-side master communication apparatus 31 receives a response from the provider-side storage battery 34, notifies the provider-side server apparatus 35 of the solar power generator ID of the solar power generator 14, and requests discharging start. The provider-side master communication apparatus 31 may transmit a discharging start request signal including the solar power generator ID of the solar power generator 14 to the provider-side server apparatus 35.

### (Step S437)

The provider-side server apparatus 35 receives the notification of the solar power generator ID and the discharging request of green power.

### (Step S438)

In response to the discharging request of green power, the provider-side server apparatus 35 notifies the electric power company facility 70 of the solar power generator ID (the solar power generator ID of the solar power generator 14 in the example illustrated in FIG. 16) and checks whether the discharging of green power can be handled (whether the provider-side storage battery 34 can be charged with green power).

### (Step S439)

The electric power company facility 70 notifies the provider-side server apparatus 35 of a response indicating whether the discharging of green power can be handled. Specifically, the electric power company facility 70 notifies the provider-side server apparatus 35 of the solar power generator ID (here, the solar power generator ID of the solar power generator 14) to return a response indicating that the discharging of green power can be handled, and notifies of the amount of green power discharged from the mobile object built-in storage battery 42 to the provider-side storage battery 34. The electric power company facility 70 may transmit a response signal including information on the solar power generator ID and the amount of green power to the provider-side server apparatus 35.

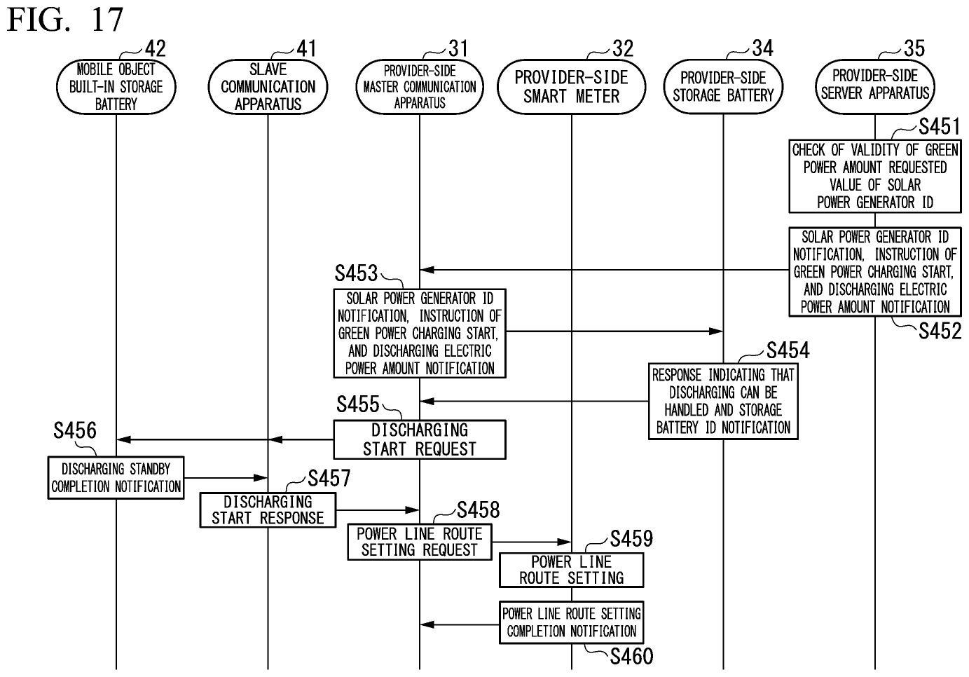

After the process illustrated in FIG. 16 has been performed, the process of the electric power system 1 proceeds to the process illustrated in FIG. 17.

FIG. 17 is a third diagram illustrating an example of a process which is performed by the electric power system 1 when the mobile object 40 discharges green energy to the provider-side charger/discharger 33.

### (Step S451)

The provider-side server apparatus 35 checks the validity of the requested value of the amount of green power which is identified by the solar power generator ID. For example, the provider-side server apparatus 35 may present the solar power generator ID to the network server apparatus 60 and check, for example, whether charging of the amount of electric power requested for the green power identified by the solar power generator ID matches an electric power transaction.

### (Step S452)

The provider-side server apparatus 35 notifies the provider-side master communication apparatus 31 of the solar power generator ID of the solar power generator 14 and the amount of discharging electric power and instructs to start charging with green power. The provider-side server apparatus 35 may transmit a green power charging start instruction signal including the solar power generator ID of the solar power generator 14 and the information on the amount of discharging electric power to the provider-side master communication apparatus 31.

### (Step S453)

The provider-side master communication apparatus 31 forwards the notification of the solar power generator ID of the solar power generator 14 and the amount of discharging electric power and the green power charging start instruction from the provider-side server apparatus 35 to the provider-side storage battery 34.

### (Step S454)

The provider-side storage battery 34 notifies the provider-side master communication apparatus 31 of a storage battery ID of the provider-side storage battery 34 which is identification information of the provider-side storage battery 34 itself and returns a response indicating that discharging can be handled, that is, charging is possible, in response to the green power charging start instruction from the provider-side master communication apparatus 31. The provider-side storage battery 34 may transmit a response signal indicating that discharging can be handled that includes the storage battery ID of the provider-side storage battery 34 to the provider-side master communication apparatus 31.

### (Step S455)

The provider-side master communication apparatus 31 requests the mobile object built-in storage battery 42 to start discharging therefrom via the slave communication apparatus 41.

### (Step S456)

The mobile object built-in storage battery 42 notifies the slave communication apparatus 41 of discharging standby completion.

### (Step S457)

The slave communication apparatus 41 returns a discharging start response to the provider-side master communication apparatus 31.

### (Step S458)

The provider-side master communication apparatus 31 requests the provider-side smart meter 32 to set a power line route. Here, the provider-side master communication apparatus 31 requests the provider-side smart meter 32 to set the power line route from the mobile object built-in storage battery 42 to the provider-side storage battery 34.

### (Step S459)

The provider-side smart meter 32 sets the power line route in response to the request for setting the power line route from the provider-side master communication apparatus 31.

### (Step S460)

The provider-side smart meter 32 notifies the provider-side master communication apparatus 31 of the fact that setting of the power line route has been completed.

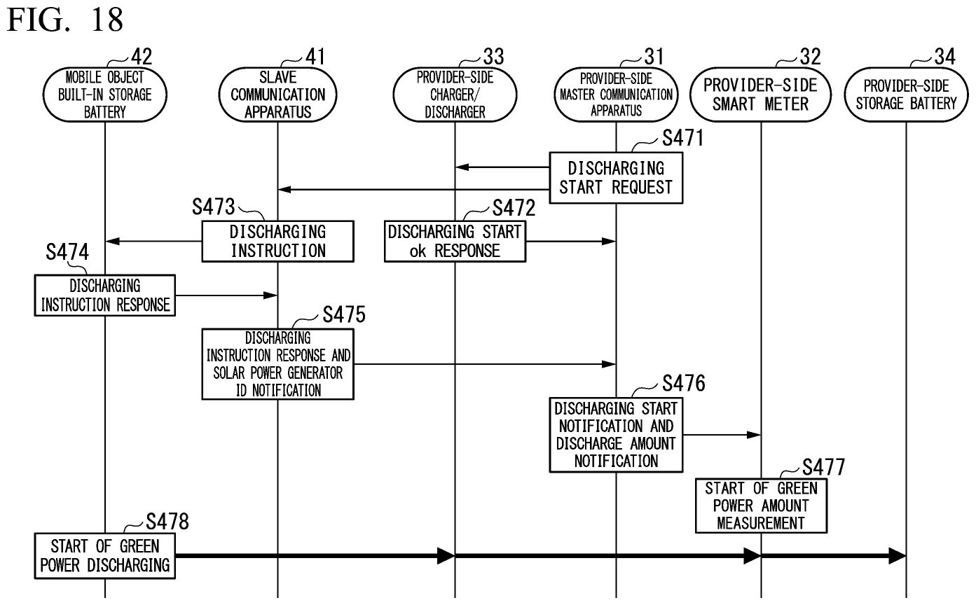

After the process illustrated in FIG. 17 has been performed, the process of the electric power system 1 proceeds to the process illustrated in FIG. 18.

FIG. 18 is a fourth diagram illustrating an example of a process which is performed by the electric power system 1 when the mobile object 40 discharges green energy to the provider-side charger/discharger 33.

### (Step S471)

The provider-side master communication apparatus 31 requests the provider-side charger/discharger 33 and the slave communication apparatus 41 to start discharging.

### (Step S472)

The provider-side charger/discharger 33 returns a response indicating that discharging can be started in response to the discharging start request from the provider-side master communication apparatus 31.

### (Step S473)

The slave communication apparatus 41 receives the discharging start request from the provider-side charger/discharger 33 and instructs the mobile object built-in storage battery 42 to start discharging.

### (Step S474)

The mobile object built-in storage battery 42 responds to the discharging instruction from the slave communication apparatus 41.

### (Step S475)

The slave communication apparatus 41 forwards the discharging instruction response from the mobile object built-in storage battery 42 to the provider-side master communication apparatus 31 and notifies the provider-side master communication apparatus 31 of the solar power generator ID of the solar power generator 14. The slave communication apparatus 41 may transmit a discharging instruction response signal including the solar power generator ID of the solar power generator 14 to the provider-side master communication apparatus 31.

### (Step S476)

The provider-side master communication apparatus 31 notifies the provider-side smart meter 32 of the start of discharging. Moreover, the provider-side master communication apparatus 31 notifies the provider-side smart meter 32 of the discharge amount. The provider-side master communication apparatus 31 may transmit a discharging start notification signal including information on the discharge amount to the provider-side smart meter 32.

### (Step S477)

The provider-side smart meter 32 starts measurement of green power.

### (Step S478)

The mobile object built-in storage battery 42 starts discharging of green power. The green power which is discharged from the mobile object built-in storage battery 42 reaches the provider-side storage battery 34 via the provider-side charger/discharger 33 and the provider-side smart meter 32, and the provider-side storage battery 34 is charged.

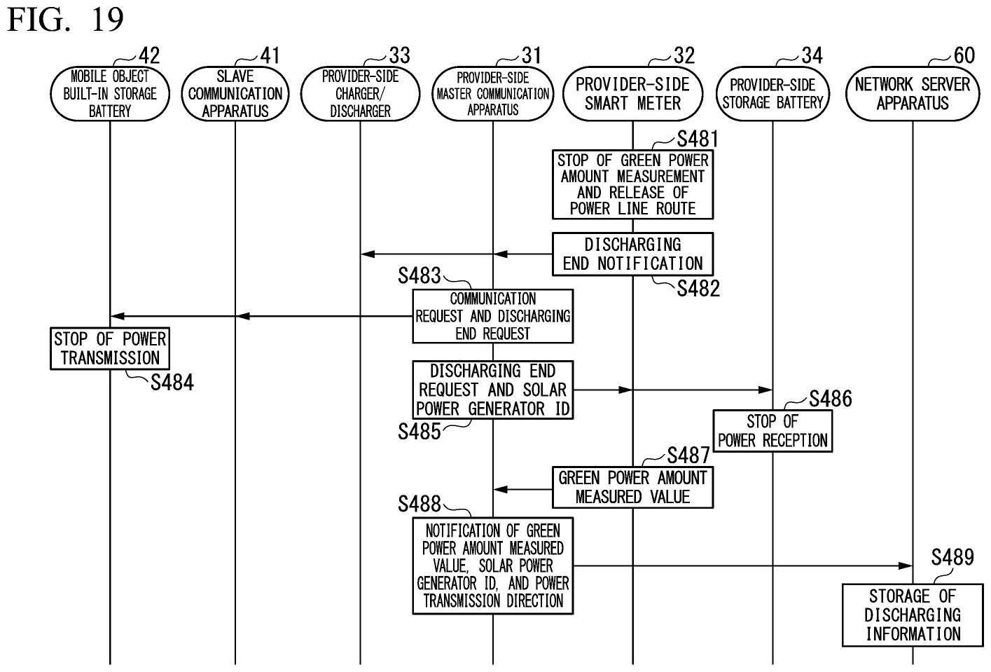

After the process illustrated in FIG. 18 has been performed, the process which is performed by the electric power system 1 proceeds to the process illustrated in FIG. 19.

FIG. 19 is a fifth diagram illustrating an example of a process which is performed by the electric power system 1 when the mobile object 40 discharges green energy to the provider-side charger/discharger 33.

### (Step S481)

When the amount of green power discharged from the mobile object built-in storage battery 42 reaches a predetermined amount of electric power, the provider-side smart meter 32 stops measurement of green power and releases the power line route.

### (Step S482)

The provider-side smart meter 32 notifies the provider-side charger/discharger 33 of end of discharging via the provider-side master communication apparatus 31.

### (Step S483)

When communication between the provider-side master communication apparatus 31 and the slave communication apparatus 41 has ended, the provider-side master communication apparatus 31 requests communication with the slave communication apparatus 41 for the purpose of a process of ending discharging of the mobile object built-in storage battery 42, and the provider-side master communication apparatus 31 and the slave communication apparatus 41 are connected such that communication between the provider-side master communication apparatus 31 and the slave communication apparatus 41 is possible.

Thereafter, the provider-side master communication apparatus 31 requests the mobile object built-in storage battery 42 to end discharging via the slave communication apparatus 41.

### (Step S484)

The mobile object built-in storage battery 42 stops transmission of green power to the provider-side storage battery 34 in response to the discharging end request from the provider-side master communication apparatus 31.

### (Step S485)

The provider-side master communication apparatus 31 notifies the provider-side storage battery 34 of the solar power generator ID of the solar power generator 14 via the provider-side smart meter 32 and requests end of discharging. The provider-side master communication apparatus 31 may transmit a discharging end request signal including the solar power generator ID of the solar power generator 14 to the provider-side smart meter 32 and the provider-side storage battery 34.

### (Step S486)

The provider-side storage battery 34 receives the discharging end request from the provider-side master communication apparatus 31 and stops receiving of green power from the mobile object built-in storage battery 42.

### (Step S487)

The provider-side smart meter 32 notifies the provider-side master communication apparatus 31 of a green power amount measured value.

### (Step S488)

The provider-side master communication apparatus 31 notifies the network server apparatus 60 of the green power amount measured value, the solar power generator ID of the solar power generator 14, and the power transmission direction.

Here, the power transmission direction is discharging of the mobile object built-in storage battery 42.

### (Step S489)

The network server apparatus 60 stores information transmitted from the provider-side master communication apparatus 31. For example, the network server apparatus 60 stores the green power amount measured value, the solar power generator ID of the solar power generator 14, and the power transmission direction in correlation with the charging time information. The network server apparatus 60 may use the time at which a notification has been received from the provider-side master communication apparatus 31 as the charging time. Alternatively, the network server apparatus 60 may acquire the charging time information from the provider-side master communication apparatus 31.

The information stored in the network server apparatus 60 can be used to check the charging/discharging information of the mobile object built-in storage battery 42 stored in the slave communication apparatus 41. For example, it is possible to check whether electric power charged into the mobile object built-in storage battery 42 is green power or non-green power using the information stored in the network server apparatus 60.

Moreover, the information stored in the slave communication apparatus 41 and the network server apparatus 60 can be used to calculate details of the green power amount and the non-green power amount out of the amount of electric power stored in the mobile object built-in storage battery 42.

The network server apparatus 60 may store one of the identification information of the mobile object 40, the identification information of the mobile object built-in storage battery 42, the amount of electric power stored in the mobile object built-in storage battery 42, and details of green power and non-green power out of the amount of electric power stored in the mobile object built-in storage battery 42 or a combination thereof in addition to the green power amount measured value, the solar power generator ID of the solar power generator 14, the power transmission direction, and the charging time information.

After Step S489, the electric power system 1 ends the process when the mobile object 40 discharges green energy to the provider-side charger/discharger 33.

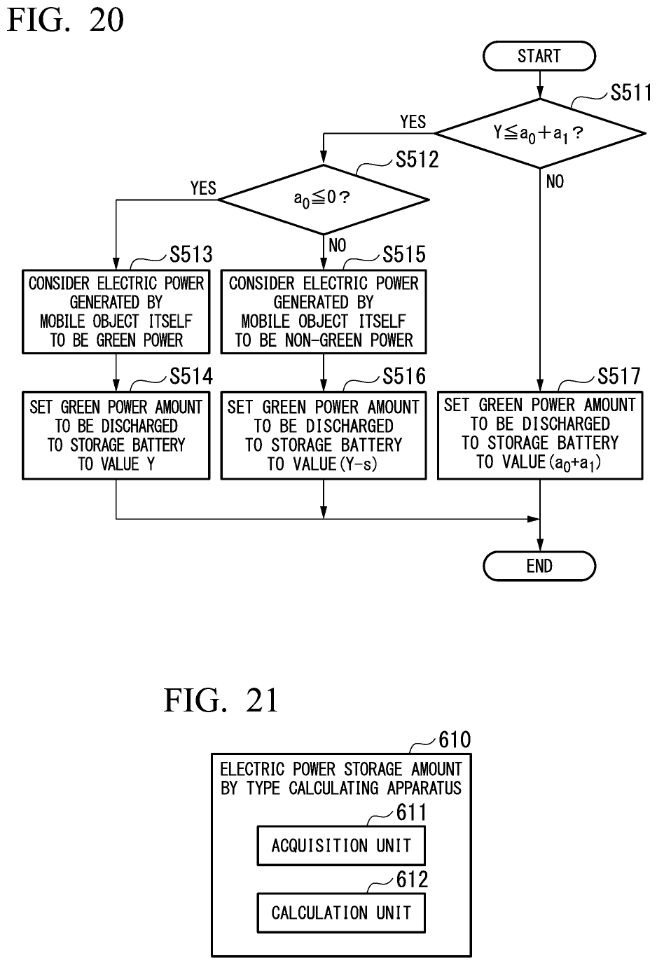

FIG. 20 is a flowchart illustrating an example of a procedure of determining the amount of green power discharged from the mobile object built-in storage battery 42 to the provider-side storage battery 34 which is performed by the network server apparatus 60. The network server apparatus 60 performs the process illustrated in FIG. 20 in Step S431 in FIG. 16.

### (Step S511)

The network server apparatus 60 determines whether the electric power storage amount Y of the mobile object built-in storage battery 42 is equal to or less than the total value of the green power amount a₀ out of the electric power storage amount of the mobile object built-in storage battery 42 in the mobile object owner facility 10 and the green power amount a₁ out of the amount of electric power with which the mobile object built-in storage battery 42 is charged in the load dispatching office facility 20 (Y≤a₀+a₁).

It should be noted that when the amount of electric power s generated by the mobile object 40 itself can be measured, the amount of generated electric power is also included in one of the green power amount a₁ and the non-green power amount b₁. That is, when electric power generated by the mobile object 40 itself is treated as green power, the network server apparatus 60 includes the amount of generated electric power in the green power amount a₁ to calculate the green power amount a₁. In contrast, when electric power generated by the mobile object 40 itself is treated as non-green power, the network server apparatus 60 includes the amount of generated electric power in the non-green power amount b₁ to calculate the non-green power amount b₁.

Whether electric power generated by the mobile object 40 is green power or non-green power can be determined in various ways. For example, all electric power generated by the mobile object 40 may be treated as non-green power.

Alternatively, when the amount of electric power generated by a power generator using power from an engine based on combustion of fossil fuels and the amount of regenerative electric power out of the amount of electric power generated by the mobile object 40 can be separately measured, the electric power generated by the power generator may be treated as non-green power and the regenerative electric power may be treated as green power as described above.

Alternatively, when the amount of regenerative electric power generated when the mobile object 40 is traveling using green power and the amount of regenerative electric power generated when the mobile object 40 is traveling using non-green power out of the regenerative electric power can be separately measured or calculated, the regenerative electric power at the time of travel using green power may be treated as green power and the regenerative electric power at the time of travel using non-green power may be treated as non-green power.

When Y≤a₀+a₁ is determined to be satisfied (Step S511: YES), the process proceeds to Step S512.

When Y>a₀+a₁ is determined to be satisfied (Step S511: NO), the process proceeds to Step S517.

### (Step S512)

The network server apparatus 60 determines whether the green power amount a₀ out of the amount of electric power stored in the mobile object built-in storage battery 42 in the mobile object owner facility 10 is equal to or less than 0 (a₀≤0). If the green power amount a₀ is equal to or less than 0, it is considered that all the green power amount a₀ stored in the mobile object built-in storage battery 42 at the time of departure from the mobile object owner facility 10 has been consumed by the mobile object 40 while traveling.

When a₀≤0 is determined to be satisfied (Step S512: YES), the process proceeds to Step S513.

When a₀>0 is determined to be satisfied (Step S512: NO), the process proceeds to Step S515.

### (Step S513)

The electric power generated by the mobile object 40 itself is considered as green power.

### (Step S514)

The network server apparatus 60 determines the green power amount discharged from the mobile object built-in storage battery 42 to the provider-side storage battery 34 to be the electric power storage amount Y of the mobile object built-in storage battery 42.

In this case, since Y≤a₀+a₁ and a₀≤0 are satisfied, the electric power storage amount Y of the mobile object built-in storage battery 42 is considered to be originated from the green power amount a₁, and all the electric power storage amount Y is considered to be the amount of green power.

In particular, all the non-green power amounts b₀ and b₁ can be considered to be consumed on the basis of the idea that electric power for travel of the mobile object 40 is consumed from the non-green power and Y≤a₀+a₁ in Step S511. Moreover, in consideration of a₀≤0 in Step S512, even when electric power generated by the mobile object 40 itself remains in the electric power storage amount Y, it is considered that electric power handled as non-green power is consumed in traveling of the mobile object 40 and electric power originated from the green power amount a₁ remains.

In this regard, it is considered that the electric power storage amount Y is based on the green power amount a₁ (or a part thereof) and a green power amount originated from the green power amount a₁ and all thereof is the amount of green power. Therefore, the network server apparatus 60 determines that all the electric power storage amount Y of the mobile object built-in storage battery 42 is discharged to the provider-side storage battery 34.

Alternatively, the network server apparatus 60 may determine that the green power amount discharged from the mobile object built-in storage battery 42 to the provider-side storage battery 34 is a remaining electric power storage amount obtained by subtracting a predetermined amount of electric power which is the amount of electric power required for movement of the mobile object 40 itself from the electric power storage amount Y of the mobile object built-in storage battery 42.

After Step S514, the network server apparatus 60 ends the process illustrated in FIG. 20.

### (Step S515)

The electric power generated by the mobile object 40 itself is considered to be non-green power.

### (Step S516)

The network server apparatus 60 determines that the green power amount discharged from the mobile object built-in storage battery 42 to the provider-side storage battery 34 is the amount of electric power (Y-s) obtained by subtracting the amount of electric power s generated by the mobile object 40 itself from the electric power storage amount Y of the mobile object built-in storage battery 42.

In this case, since the green power amount a₀ stored in the mobile object built-in storage battery 42 when the mobile object 40 departs from the mobile object owner facility 10 remains in the mobile object built-in storage battery 42, there is a possibility that some or all of the electric power (the amount of electric power s) generated by the mobile object 40 itself will remain in the mobile object built-in storage battery 42. Since there is a possibility that the electric power generated by the mobile object 40 itself will be non-green power, the network server apparatus 60 determines that the amount of electric power Y-s obtained by subtracting the amount of electric power s generated by the mobile object 40 itself from the electric power storage amount Y of the mobile object built-in storage battery 42 is discharged to the provider-side storage battery 34.

After Step S516, the network server apparatus 60 ends the process illustrated in FIG. 20.

### (Step S517)

The network server apparatus 60 determines that the green power amount discharged from the mobile object built-in storage battery 42 to the provider-side storage battery 34 is the total value (a₀+a₁) of the green power amount a₀ out of the amount of electric power stored in the mobile object built-in storage battery 42 in the mobile object owner facility 10 and the green power amount a₁ out of the amount of electric power charged into the mobile object built-in storage battery 42 in the load dispatching office facility 20.

After Step S517, the network server apparatus 60 ends the process illustrated in FIG. 20.

As described above, the acquisition unit 64 acquires charging/discharging history information in which the charge amount/discharge amount of the mobile object built-in storage battery 42 is correlated with the type of electric power and electric power storage amount information indicating the amount of electric power stored in the mobile object built-in storage battery 42. The calculation unit 65 calculates the electric power storage amount of the mobile object built-in storage battery 42 by the types of electric power on the basis of the charging/discharging history information and the electric power storage amount information.

Accordingly, the network server apparatus 60 can calculate the electric power storage amount of the mobile object built-in storage battery 42 by the types of electric power such as green power and non-green power, and can sell a specific type of electric power such as selling green power out of the electric power stored in the mobile object built-in storage battery 42.

Moreover, the acquisition unit 64 additionally acquires generated electric power amount information indicating the amount of electric power generated by the mobile object 40. The calculation unit 65 calculates the electric power storage amount of the mobile object built-in storage battery 42 by the types of electric power additionally on the basis of the generated electric power amount information.

With the network server apparatus 60, it is possible to calculate the electric power storage amount of the mobile object built-in storage battery 42 by the types of electric power while reflecting the amount of electric power generated by the mobile object 40. In this respect, with the network server apparatus 60, it is possible to more accurately calculate the electric power storage amount for each type of electric power of the mobile object built-in storage battery 42.

Moreover, the mobile object built-in storage battery 42 can handle both of a case in which the electric power generated by the mobile object 40 is treated as green power and a case in which the electric power generated by the mobile object 40 is treated as non-green power, and it is possible to calculate the electric power storage amount for each type of electric power of the mobile object built-in storage battery 42.

Moreover, the acquisition unit 64 additionally acquires a measured value of the charge/discharged amount of the storage battery which are measured by the charge amount sensor 44 and the discharge amount sensor 45 provided in the mobile object 40 when the mobile object 40 is moving. The calculation unit 65 calculates the electric power storage amount of the mobile object built-in storage battery 42 by the types of electric power additionally on the basis of the measured value of the charge/discharge amount of the storage battery which are measured when the mobile object 40 is moving.

With the network server apparatus 60, it is possible to more accurately acquire the charge/discharge amount of the mobile object built-in storage battery 42 at the time of movement of the mobile object 40 using the sensors. In this respect, with the network server apparatus 60, it is possible to more accurately calculate the electric power storage amount for each type of electric power of the mobile object built-in storage battery 42.

Moreover, the acquisition unit 64 acquires the charging/discharging history information in which the amount of green power with which the mobile object built-in storage battery 42 is charged and identification information of the power generation facility having generated the green power are correlated.

Accordingly, the network server apparatus 60 can check the validity of charging records of green power by, for example, searching for the records of green power using the identification information of the power generation facility.

Moreover, when charging of the mobile object built-in storage battery 42 is performed in the load dispatching office facility 20 on the movement route of the mobile object 40, the calculation unit 65 calculates the electric power storage amount of the mobile object built-in storage battery 42 at the end of charging in the load dispatching office facility 20 by the types of electric power on the basis of the electric power storage amount for each type of electric power before the mobile object 40 starts movement and the electric power storage amount in the load dispatching office facility 20.

With the network server apparatus 60, by calculating information of a state of charge of the mobile object built-in storage battery 42 in the load dispatching office facility 20, it is possible to reflect a power consumption situation while the mobile object 40 is moving in calculation of the electric power storage amount for each type of electric power of the mobile object built-in storage battery 42 when the mobile object 40 arrives at the provider facility 30. In this respect, with the network server apparatus 60, it is possible to calculate the electric power storage amount for each type of electric power of the mobile object built-in storage battery 42 so as to more conform to the actual condition. For example, with the network server apparatus 60, it is possible to reflect the fact that the non-green power amount is not sufficient for the amount of consumed electric power of the mobile object 40 and the green power amount is also consumed, in the electric power storage amount for each type of electric power of the mobile object built-in storage battery 42.

FIG. 21 is a diagram illustrating an example of a configuration of the electric power storage amount by type calculating apparatus according to an example embodiment. In the configuration illustrated in FIG. 21, the electric power storage amount by type calculating apparatus 610 includes an acquisition unit 611 and a calculation unit 612.

With this configuration, the acquisition unit 611 acquires charging/discharging history information in which charge/discharge amounts of a storage battery of a mobile object and a type of electric power are correlated and electric power storage amount information indicating the amount of electric power stored in the storage battery. The calculation unit 612 calculates the amount of electric power stored in the storage battery by the types of electric power on the basis of the charging/discharging history information and the electric power storage amount information.

Accordingly, the electric power storage amount by type calculating apparatus 610 can calculate the amount of electric power stored in the storage battery by the types of electric power such as green power and non-green power and sell a specific type of electric power like selling green power out of the electric power stored in the storage battery.

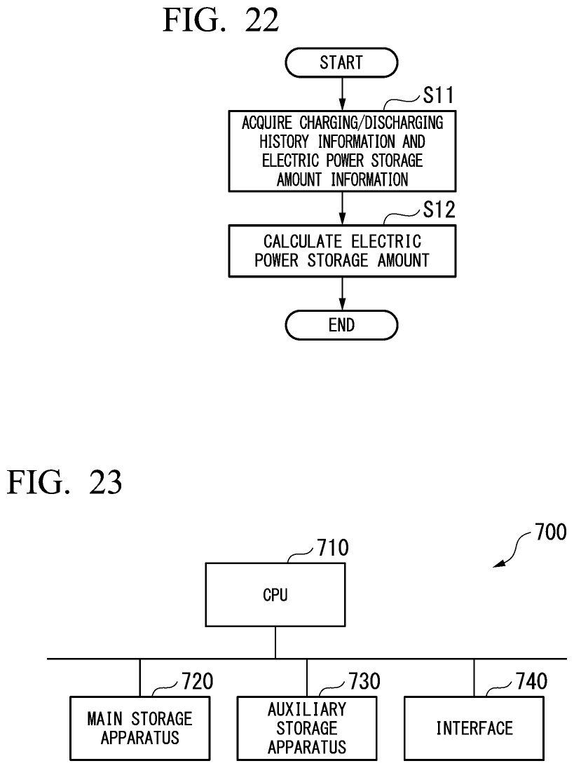

FIG. 22 is a flowchart illustrating an example of a procedure of the electric power storage amount by type calculating method according to an example embodiment. The process illustrated in FIG. 22 includes a step of acquiring charging/discharging history information and electric power storage amount information (Step S11) and a step of calculating the electric power storage amount by the types of electric power (Step S12).

In the step of acquiring the charging/discharging history information and the electric power storage amount information, the charging/discharging history information in which the charge/discharge amount of a storage battery of a mobile object and a type of electric power are correlated and electric power storage amount information indicating the amount of electric power stored in the storage battery are acquired. In the step of calculating the electric power storage amount for each type of electric power, the amount of electric power stored in the storage battery is calculated by the types of electric power on the basis of the charging/discharging history information and the electric power storage amount information.

With the processing method illustrated in FIG. 22, it is possible to calculate the amount of electric power stored in the storage battery by the types of electric power such as green power and non-green power and to sell a specific type of electric power like selling green power out of the electric power stored in the storage battery.

FIG. 23 is a block diagram schematically illustrating a configuration of a computer according to at least one example embodiment.

In the configuration illustrated in FIG. 23, a computer 700 includes a central processing unit (CPU) 710, a main storage apparatus 720, an auxiliary storage apparatus 730, and an interface 740.

One or more of the network server apparatus 60 and the electric power storage amount by type calculating apparatus 610 may be implemented in the computer 700. In this case, the operations of the respective processing units are stored in the form of a program in the auxiliary storage apparatus 730. The CPU 710 reads the program from the auxiliary storage apparatus 730, loads the read program to the main storage apparatus 720, and performs the above processes in accordance with the program. Moreover, the CPU 710 secures a storage area corresponding to the respective storage units described above in the main storage apparatus 720 in accordance with the program.

When the network server apparatus 60 is implemented in the computer 700, the operations of the control unit 63 and the respective units thereof are stored in the form of a program in the auxiliary storage apparatus 730. The CPU 710 reads the program from the auxiliary storage apparatus 730, loads the read program to the main storage apparatus 720, and performs the above processes in accordance with the program.

Moreover, the CPU 710 secures a storage area corresponding to the storage unit 62 in the main storage apparatus 720 in accordance with the program.

Communication by the communication unit 61 is executed by providing the interface 740 with a communication function and performing communication under the control of the CPU 710.

When the electric power storage amount by type calculating apparatus 610 is implemented in the computer 700, the operations of the acquisition unit 611 and the calculation unit 612 are stored in the form of a program in the auxiliary storage apparatus 730. The CPU 710 reads the program from the auxiliary storage apparatus 730, loads the read program to the main storage apparatus 720, and performs the above processes in accordance with the program.

It should be noted that a program for realizing some or all of the functions of the network server apparatus 60 and the electric power storage amount by type calculating apparatus 610 may be recorded in a computer-readable recording medium and causing a computer system to read the program stored in the recording medium and execute the program, thereby performing the process of the respective units. A “computer system” mentioned here includes an operating system (OS) and hardware such as peripheral devices.

Examples of a “computer-readable recording medium” include a portable medium such as a flexible disk, a magneto-optical disc, a read only memory (ROM), and a compact disc-read only memory (CD-ROM) and a storage apparatus such as a hard disk embedded in a computer system. Moreover, the program may be a program for realizing some of the aforementioned functions or may be a program which can realize the aforementioned functions in combination with a program which has already been stored in a computer system.

While the present invention has been particularly shown and described with reference to example embodiments thereof, the present invention is not limited to these example embodiments. It will be understood by those of ordinary skill in the art that various changes in form and details may be made therein without departing from the spirit and scope of the present invention as defined by the claims.

What is claimed is:

1. An electric power storage amount by type calculating apparatus comprising:
a memory configured to store instructions; and
a processor configured to execute the instructions to:
acquire charging/discharging history information in which a charge/discharge electric power amount of a storage battery of a mobile object and a type of electric power are correlated and electric power storage amount information indicating an amount of electric power stored in the storage battery; and
calculate the amount of electric power stored in the storage battery by types of electric power on the basis of the charging/discharging history information and the electric power storage amount information.

2. The electric power storage amount by type calculating apparatus according to claim 1, wherein the processor is configured to additionally acquire generated electric power amount information indicating an amount of electric power generated in the mobile object and calculate the amount of electric power stored in the storage battery by the types of electric power additionally on the basis of the generated electric power amount information.

3. The electric power storage amount by type calculating apparatus according to claim 1, wherein the processor is configured to: additionally acquire a measured value of the charge/discharge electric power amount of the storage battery measured by a sensor that is provided in the mobile object when the mobile object is moving; and calculate the amount of electric power stored in the storage battery by the types of electric power additionally on the basis of the measured value.

4. The electric power storage amount by type calculating apparatus according to claim 1, wherein the processor is configured to acquire information in which an amount of green power charged into the storage battery and identification information of a power generation facility having generated the green power are correlated as the charging/discharging history information.

5. The electric power storage amount by type calculating apparatus according to claim 1, wherein the processor is configured to, in a case in which charging of the storage battery has been performed in a load dispatching office facility on a movement route of the mobile object, calculate the amount of electric power stored in the storage battery when the charging of the storage battery in the load dispatching office facility has ended by the types of electric power on the basis of an amount of electric power stored in the storage battery by the types of electric power before the mobile object starts movement and an amount of electric power stored in the storage battery in the load dispatching office facility.

6. An electric power storage amount by type calculating method comprising:
acquiring charging/discharging history information in which a charge/discharge electric power amount of a storage battery of a mobile object and a type of electric power are correlated and electric power storage amount information indicating an amount of electric power stored in the storage battery; and
calculating the amount of electric power stored in the storage battery by types of electric power on the basis of the charging/discharging history information and the electric power storage amount information.

7. A non-transitory computer-readable recording medium storing a program for causing a computer to perform:
acquiring charging/discharging history information in which a charge/discharge electric power amount of a storage battery of a mobile object and a type of electric power are correlated and electric power storage amount information indicating an amount of electric power stored in the storage battery; and
calculating the amount of electric power stored in the storage battery by types of electric power on the basis of the charging/discharging history information and the electric power storage amount information.
